(19) United States
(12) Patent Application Publication
(10) Pub. No.: US 2002/0020249 A1
(43) Pub. Date: Feb. 21, 2002

(54) Integrated rider control system for handlebar steered vehicles

(76) Inventors: Todd J. Darland, Westfield, IN (US); Charles M. Goldman, Chicago, IL (US); Kent A. Solberg, Chicago, IL (US); Jacques P. Greetis, Chicago, IL (US)

Correspondence Address: Milan Milosevic, SRAM Corporation, 4th Floor, 1333 North Kingsbury, Chicago, IL, 60622, US

(21) Appl. No.: 09/849,114

(22) Filed: May 4, 2001

Related U.S. Application Data
(63) Continuation-in-part of application No. 09/526,659, filed on Mar. 15, 2000.
Application No. 09/526,659 is a continuation-in-part of application No. 09/544,405, filed on Apr. 6, 2000.

(51) Int. Cl. B62K 21/12

(52) U.S. Cl. 74/551.8

(57) ABSTRACT

A rider steering control device pivotally coupled to a frame of a bicycle has a one-piece elongate support structure defining at least one cavity having a plurality of first mounting surfaces. The support structure includes an integrally formed central region configured for pivotally coupling to the bicycle frame. At least one accessory has a second mounting surface matably engaging a selected first mounting surface of the support structure within the cavity.

### TECHNICAL FIELD OF THE INVENTION

The present invention relates generally to the field of rider control systems for handlebar steered vehicles. More particularly, the invention relates to an integrated rider control system which integrates a handlebar with various controls, accessories and displays.

### BACKGROUND OF THE INVENTION

Conventional handlebar assemblies typically include a tubular member transversely positioned with respect to the longitudinal axis of the bicycle, motorcycle, or other handlebar steered vehicle. These conventional tubular handlebars can be formed into one of a number of different shapes, such as a straight bar, a U-shape, and a ram horn shape. These handlebar assemblies commonly have additional equipment such as vehicle controls, accessories or displays. Controls typically include devices such as shifters and brakes. Displays can include devices such as shifter displays, computer displays, etc. Accessories typically include devices such as bells, bags, horns and mirrors. Typically, this equipment is mounted on the tubular handlebar assemblies with clamps, bands, clips or other substantially exposed fasteners. Often the mounting of this equipment on the tubular handlebar is performed on a piece-meal basis.

A representative prior art structure of a handlebar assembly is shown in FIG. 1. The prior art handlebar assembly of FIG. 1 uses a cylindrical tubular metallic handlebar 10 having a plurality of accessories 11 clamped on to the handlebar assembly leaving a number of sharp metal surfaces and fasteners exposed. The equipment mounting on the prior art handlebar structure encroaches into the rider's space and reduces the locations available to the rider for gripping the handlebar assembly.

Existing handlebar assemblies for handlebar steered vehicles and handlebar mounted equipment have a number of further drawbacks. First, existing handlebar assemblies provide limited surface area for the mounting of existing additional equipment. The limited availability of mounting space on existing handlebar assemblies contributes to improper, inefficient or ineffective mounting and location of the additional equipment. The improper mounting configurations of the additional equipment can obstruct the user's view, encroach into the riding space of the rider, conflict with the manipulation of other handlebar-mounted equipment and reduce the surface area and the number of locations available to the rider for gripping the handlebar assembly. Moreover, the tubular shape of existing handlebar assemblies severely limits the number and types of compatible fasteners for the mounting of the additional equipment to the handlebar assembly. A problem inherent with conventional tubular handlebars is that their circular cross section offers little resistance to torque-generating forces; for example, a brake lever mounted with a conventional clamp to a cylindrical handlebar will be prone to slip under even moderate degrees of torque.

Second, as above mentioned existing handlebar mounted equipment is substantially externally mounted has exposed clamps, clips, cables and fasteners. These existing exposed accessories, controls, displays, clamps and fasteners often include sharp metallic surfaces all of which can, and often do, cause injury to a vehicle user who contacts these devices during operation of the vehicle. The prior art solution has been to employ a cover, such as a soft cap, over the exposed sharp metal surfaces or fasteners. The exposed cables and wires connecting the equipment are clumsy and susceptible to entanglement with and damage by foreign objects during operation of the vehicle. The externally mounted equipment can be easily removed or broken away by thieves or vandals. This susceptibility of existing equipment to theft severely limits the user's ability and freedom to easily store or leave the vehicle unattended. The externally mounted equipment are often and easily dislodged from their desired positions by contact with the user or a foreign object leading to premature failure or contributing to repeated and excessive readjustment of the equipment.

Third, existing, handlebar assemblies for handlebar steered vehicles can fail, leaving the user with severely limited ability to control the vehicle and increasing the probability of serious injury to the rider or others. Existing single-bar handlebar assemblies will often fail in environments in which large stresses are placed on the handlebar, such as occur in mountain biking and other off-road applications.

Finally, existing handlebar assemblies are typically axially symmetrical and have a pair handgrips or a pair of control actuators (such as shifters or brakes) on each side of the handlebar assembly that are difficult to align with respect to one another. The user often must make repeated “eye-ball” adjustments before obtaining the desired symmetrical and rotational positioning of the handgrips or the actuators.

Accordingly, it would be advantageous to provide a handlebar assembly for handlebar steered vehicles that provides for integrated attachment of various equipment. In particular, it would be advantageous to provide an integral rider control device that integrally and receivably accommodates equipment. What is needed is an integral rider control device that includes additional mounting surfaces and receiving ports for equipment. There is a continuing need for an integrated rider control system that ergonomically optimizes the location of hand gripping surfaces and the positioning of equipment such that the rider's view is not obstructed and encroachment into the rider's space is minimized. There is a further need for a rider control system that is adaptable to a greater variety of fasteners and fastening techniques. It would be advantageous to provide a rider control system that eliminates sharp metallic surfaces projecting from equipment and their fasteners. There is also a continuing need for an integrated rider control system that minimizes the amount of exposed cables extending between the equipment. What is needed is an integrated rider control system that integrates equipment into the control system thereby significantly reducing the susceptibility of the equipment to theft or dislocation by contact with the rider or foreign objects. There is a need for an integrated rider control system that allows for easy, accurate and efficient alignment of hand grips or actuators with respect to each other. There is a need to provide an integrated rider control system having a fail safe design configured to back up the primary load bearing rider control assembly. It would also be advantageous to provide an integrated rider control system with a greater hand grip adjustment range of motion than existing handlebar assemblies. Finally, it would be advantageous to provide an integrated rider control system that includes the features specified above and has an inherent, aesthetically appealing appearance.

### SUMMARY OF THE INVENTION

In a first aspect of the present invention, a rider steering control device is configured to hide sharp edges of a fastener or connections between an accessory and a handlebar. This configuration results in an appearance of integral formation with the accessories that prevents the rider from harming himself or herself on the connections or damaging the connections.

More specifically, a rider steering control device pivotally coupled to a frame of a bicycle has a one-piece elongate support structure defining a cavity and has at least one non-cylindrical first mounting surface. The support structure includes an integrally formed central region configured for pivotally coupling to the bicycle frame. At least one accessory has a second mounting surface matably engaging the first mounting surface of the support structure. The cavity is configured for at least partially covering the connection between the accessory and the support structure.

In a second aspect of the present invention, the rider control system includes a spar with a covered cavity for hiding a fastener that extends through the spar. In more detail, a rider steering control device for a bicycle is configured for attachment via a fastener of at least one accessory and has at least one elongate first spar pivotally coupled to the bicycle. The first spar has first and second end sections, generally opposing first outer and second outer surfaces, and at least two sidewalls extending from the first outer surface to a bottom wall to define an elongate cavity disposed between the first and second end sections of the first spar and between the sidewalls. The first spar also has at least one through-hole extending through its bottom wall from the cavity to the second outer surface. The through-hole is configured to receive at least a portion of the fastener for connecting the accessory to the first spar. A cover is attached to the first spar for covering at least a portion of the cavity.

In a third aspect of the present invention, an accessory bar is provided that can be snapped onto a bicycle steering control designed for that purpose for substantially adding the number of accessories that can be carried on the steering control, and for enhancing the convenience of installation or removal. More particularly, an accessory mounting system has an accessory support member for supporting at least one accessory and is configured for mounting to a steering control device of a bicycle. The support member includes an elongate bar having opposing first and second interference surfaces laterally spaced apart by a third surface. The first and second surfaces are positioned substantially orthogonal to the third surface, and the first and second surfaces of the bar are configured to matably engage first and second opposing abutments, respectively, of the steering control device so that the engagement deflects the bar for securing the bar between the abutments. At least one accessory mounting region is also defined on the bar.

In a fourth aspect of the present invention, an accessory bar is provided with an integrated accessory and control system remote from the accessory so that the rider does not have to handle the accessory itself, such as might be the case in which the accessory itself is mounted in a way which is relatively inaccessible to the rider. This system also integrates any communication link between the accessory and the control so that the link is not susceptible to damage or rider injury. In a preferred embodiment, an accessory support member for supporting at least one accessory is configured for mounting to a steering control device of a bicycle. The support member also has an elongate tubular bar defining an accessory mounting region and an accessory control connected to the bar and disposed remotely from the accessory mounting region. An accessory is mounted to the bar, and a communications link connects the accessory control to the accessory. The communications link is configured so that it is not exposed to an exterior of the bar, and the bar is removably secured on the steering control device.

In a fifth aspect of the present invention, an accessory or equipment bar is adapted to attach to known tubular bicycle handlebars, with the same advantages explained in the first through fourth aspects, which equipment bar prevents harm to a rider, prevents damage to the equipment and provides an integral appearance of a combination of the equipment and the accessory bar itself. Particularly, an equipment mounting bar for a tubular handlebar of a bicycle has an elongated first spar having first and second attachment ends for attaching to the tubular handlebar, opposing first and second outer surfaces between the first and second attachment ends, two elongated sidewalls and a bottom wall cooperatively defining an elongate cavity. An accessory may be mounted in this cavity.

### BRIEF DESCRIPTION OF THE DRAWINGS

The invention will become more fully understood from the following detailed description, taken in conjunction with the accompanying drawings, wherein like reference numerals refer to like parts, in which:

FIG. 1 is a top perspective view of a prior art bicycle handlebar assembly including a plurality of accessories;

FIG. 2 is a top perspective view of an integrated rider control system in accordance with an exemplary embodiment of the present invention;

FIG. 3 is a rear, side perspective view of the integrated rider control system of FIG. 2;

FIG. 4 is a front, side perspective view of the integrated rider control system of FIG. 2;

FIG. 5 is rear exploded perspective view of the integrated rider control system of FIG. 2;

FIG. 6 is a front exploded perspective view of the integrated rider control system of FIG. 2;

FIG. 7A is a side view of an integrated rider control system in accordance with an exemplary embodiment of the present invention with a stem thereof in a forwardly extending position;

FIG. 7B is a side view of an integrated rider control system in accordance with an exemplary embodiment of the present invention with the stem in a rearwardly extending position;

FIG. 8 is a rear view of an integral support structure in accordance with an exemplary embodiment of the present invention;

FIG. 9 is a front view of the integral support structure of FIG. 8;

FIG. 10 is a top view of the integral support structure of FIG. 8;

FIG. 11 is a rear view of the integral support structure of FIG. 8;

FIG. 12 is a bottom view of the integral support structure of FIG. 8;

FIG. 13 is a perspective view of a cushionable cover for the integral support structure in accordance with an exemplary embodiment of the present invention;

FIG. 14 is a bottom view of the cushionable cover of FIG. 13;

FIG. 15 is a rear perspective exploded view illustrating the assembly of the cushionable cover to the integral support structure of FIG. 8;

FIG. 16 is a rear perspective partially exploded view illustrating cable routing within the integral support structure of FIG. 8;

FIG. 17 is a rear perspective view of an integral support structure in accordance with an exemplary embodiment of the present invention;

FIG. 18 is a cross-sectional view of an upper spar of the integral support structure taken substantially along line 18-18 of FIG. 17;

FIG. 19A is a cross-sectional view of a handlebar adapter in accordance with an exemplary embodiment of the present invention;

FIG. 19B is a front perspective view of the integral support structure illustrating the attachment of an accessory to the support structure using the handlebar adapter of FIG. 19A;

FIG. 20 is a rear perspective view of an integral support structure in accordance with an exemplary embodiment of the present invention;

FIG. 21 is a cross-sectional view of a lower spar of the integral support structure taken substantially along line 21-21 of FIG. 20;

FIG. 22 is rear exploded view of the integral support structure of FIG. 20 illustrating the cable attachment to the lower spar of the integral support structure;

FIG. 23 is a rear perspective view of an integral support structure in accordance with an exemplary embodiment of the present invention;

FIG. 24 is an exploded cross-sectional view of the lower spar of the integral support structure taken along line 24-24 of FIG. 23 illustrating cable attachment to the lower spar;

FIG. 25 is a front sectional exploded view of an integrated rider control system in accordance with an exemplary embodiment of the present invention;

FIG. 26 is an exploded view of a dial gear indication device in accordance with an exemplary embodiment of the present invention;

FIG. 27 is a cross-sectional view of the dial gear indication device of FIG. 26;

FIG. 28 is a rear perspective view of an integral support structure including an LED gear indication device;

FIG. 29 is a front perspective view of an integrated rider control system in accordance with an exemplary embodiment of the present invention;

FIG. 30 is a front perspective view of an integrated rider control system in accordance with an exemplary embodiment of the present invention;

FIGS. 31A through 31I are front perspective views of accessories in accordance with an exemplary embodiment of the present invention;

FIG. 32 is an exploded perspective view of an integrated rider control system illustrating a plurality of accessories in accordance with an exemplary embodiment of the present invention;

FIG. 33 is a rear exploded view of a control pod in accordance with an exemplary embodiment of the present invention;

FIG. 34 is a rear partially exploded view of the control pod of FIG. 33;

FIG. 35 is a front perspective view of a bicycle control assembly in accordance with an exemplary embodiment of the present invention;

FIG. 36 is a rear exploded view of the right end of the integral support structure in accordance with an exemplary embodiment of the present invention;

FIG. 37 is a side perspective view of an integrated rider control system in accordance with an exemplary embodiment of the present invention illustrating the operating adjustable range of the system;

FIG. 38 is side perspective view of a prior art bicycle handlebar assembly having a 90 millimeter stem extension;

FIG. 39 is side perspective view of a prior art bicycle handlebar assembly having a 105 millimeter stem extension;

FIG. 40 is side perspective view of a prior art bicycle handlebar assembly having a 120 millimeter stem extension;

FIG. 41 is a rear, side perspective view of an integrated rider control system in accordance with an exemplary embodiment of the present invention;

FIG. 42 is a rear view of the integrated rider control system of FIG. 41;

FIG. 43 is an exploded rear perspective view of a modular rider control system in accordance with an exemplary embodiment of the present invention;

FIG. 44 is an exploded rear perspective view of a modular rider control system in accordance with an exemplary embodiment of the present invention;

FIG. 45 is a rear perspective view of a rider steering control device in accordance with an exemplary embodiment of the present invention;

FIG. 46 is an exploded, fragmentary view illustrating non-cylindrical mounting surfaces of a support structure and an accessory for the rider steering control device of FIG. 45;

FIG. 47 is an exploded view of a rider steering control device in accordance with an exemplary embodiment of the present invention;

FIG. 48 is a top perspective view of the rider steering control device of FIG. 47;

FIG. 49 is an exploded, top perspective view of an accessory mounting system in accordance with an exemplary embodiment of the present invention;

FIG. 50 is a top perspective view of an alternative rider control system of the present invention;

FIG. 51 is a top perspective view of another alternative rider control system of the present invention; and

FIG. 52 is a top perspective view of yet another alternative rider control system.

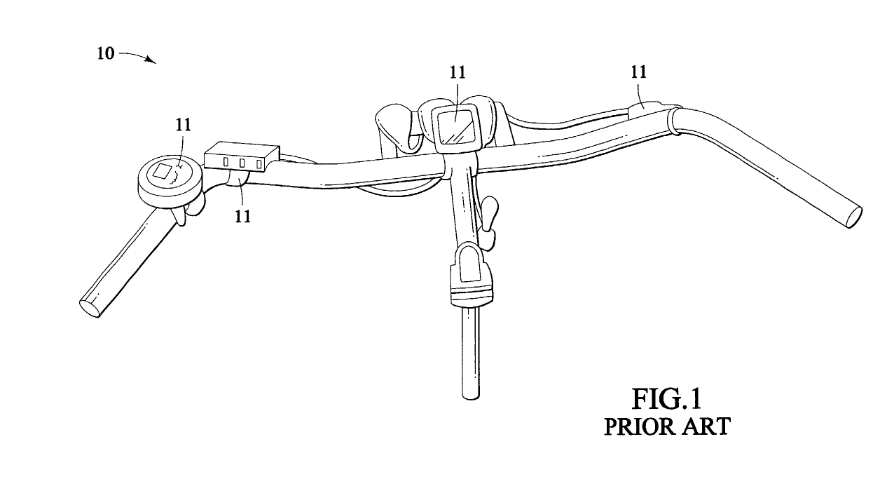

### DETAILED DESCRIPTION OF ILLUSTRATED EMBODIMENT

I. Integrated Rider Control System

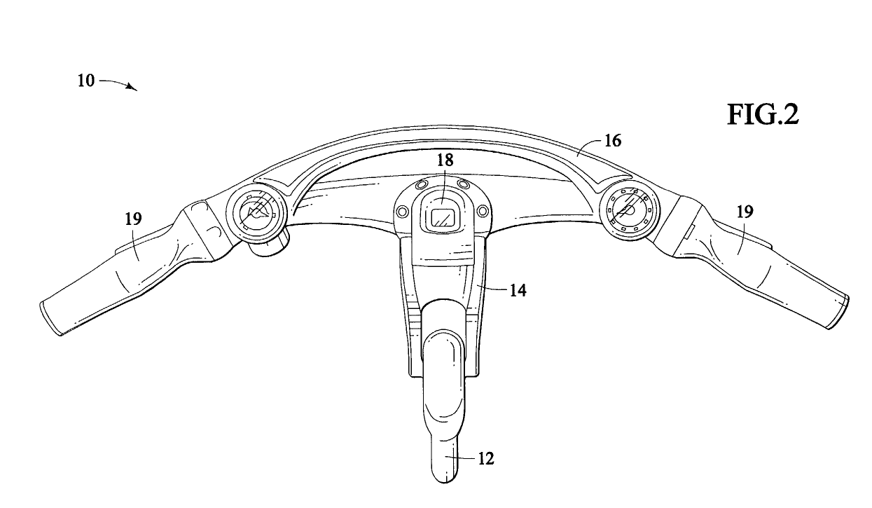

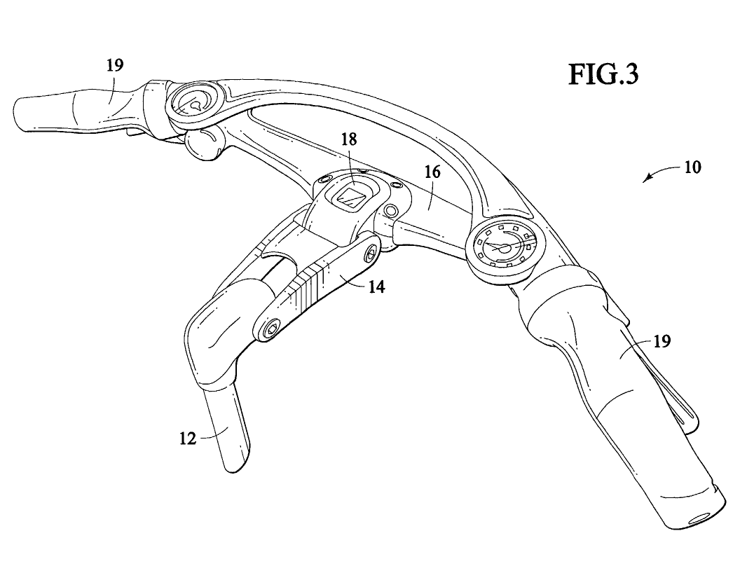

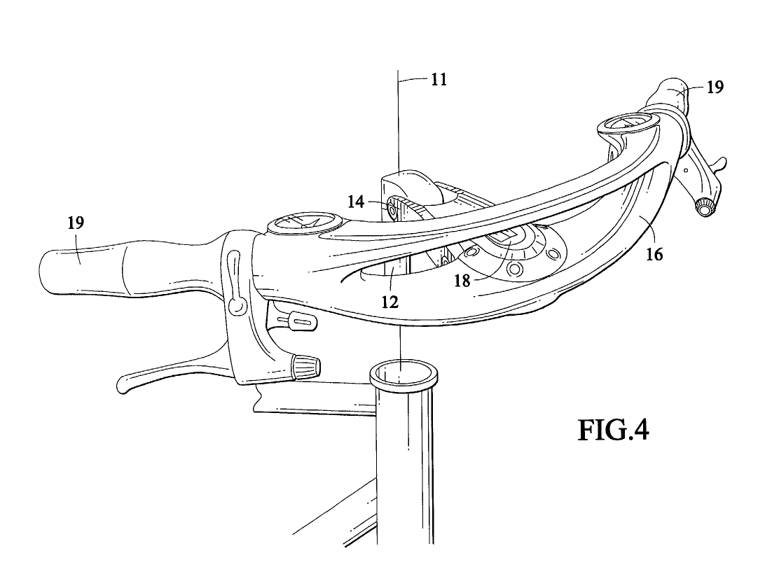

FIGS. 2 through 6 illustrate one embodiment of an integrated rider control system 10 for handlebar steered vehicles. Handlebar steered vehicles can be bicycles, motorcycles, personal watercrafts, mopeds, snowmobiles, etc. As illustrated in FIG. 4, system 10 is configured to pivotally couple along a steering axis 11 to the handlebar steered vehicle. As illustrated FIG. 3, system 10 includes a stem 12, an extension 14, an integral support structure 16, at least one accessory, shown as a computer 18, and integrated brake gear shifters, shown as control pods 19.

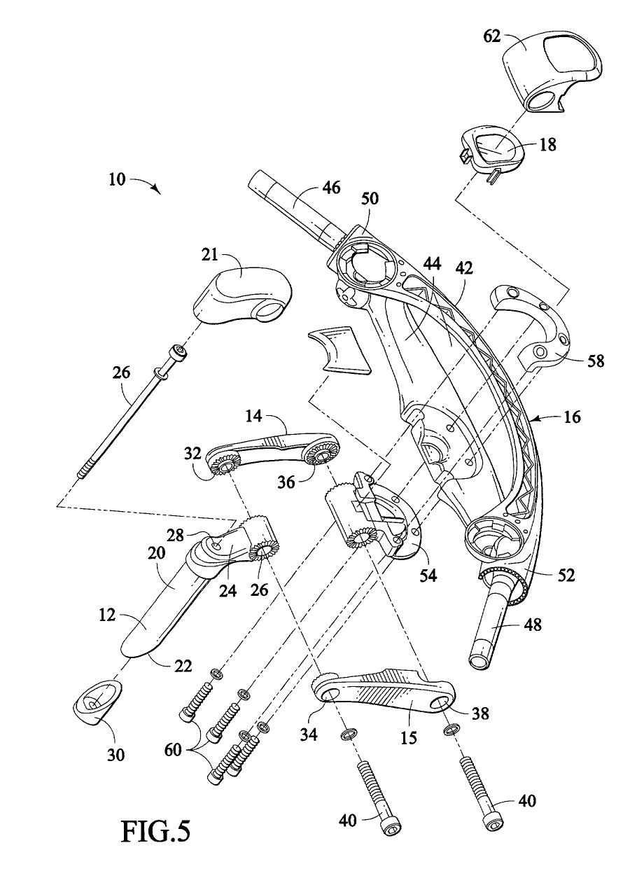

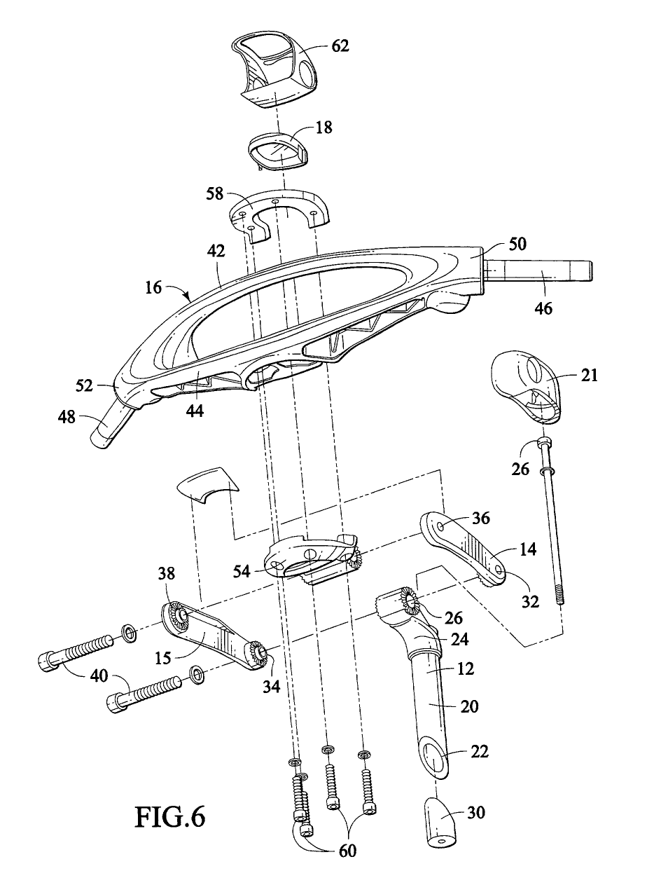

As best illustrated in FIGS. 5 and 6, stem 12 is an elongate cylindrical hollow quill 20 having an obliquely cut frame end 22 and a distal end 24. Stem 12 is positioned at a forward end of the vehicle. In an exemplary embodiment, distal end 24 angularly projects from quill 20 and includes a distal end opening 26 transversely positioned with respect to a longitudinal axis of the vehicle. Quill 20 of stem 12 is configured to pivotally couple to and generally upwardly project from the frame (not shown) along the steering axis of the vehicle of the handlebar steered vehicle. Quill 20 includes an elongate bolt 26 extending through a longitudinal passage 28 of quill 20. Bolt 26 is configured to connect to a wedge 30 at frame end 22 of quill 20. During assembly, bolt 26 pulls wedge 30 up against oblique frame end 22 expanding the cross sectional area of stem 12 at frame end 22 of quill 20 until it removably binds with inner surfaces of a fork tube (not shown) of the vehicle. In an alternative embodiment, frame end 22 of quill can be configured to connect with outer surfaces of the fork tube. Stem 12 connects integrated rider control system 10 to the vehicle and supports extension 14 and integral support structure 16. Stem 12 is made of an impact modified, glass-filled nylon. Stem 12 can also be made of metal, aluminum, polymers, etc.

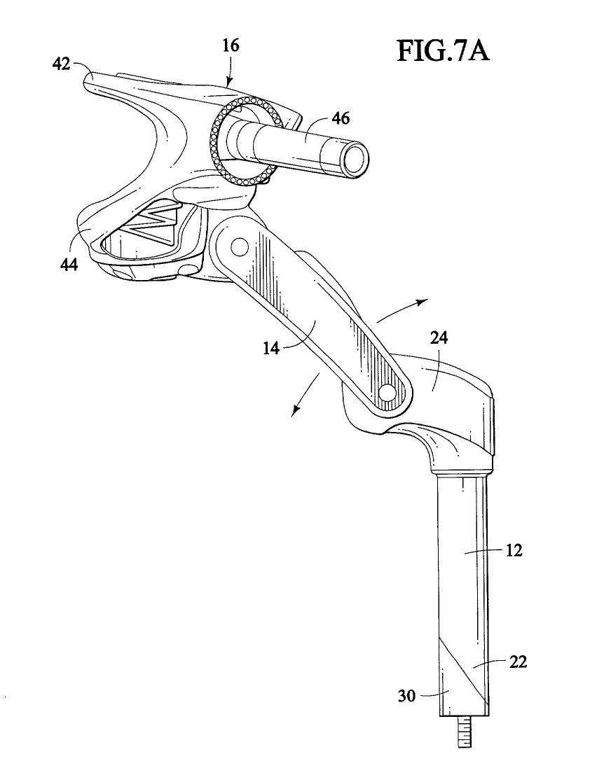

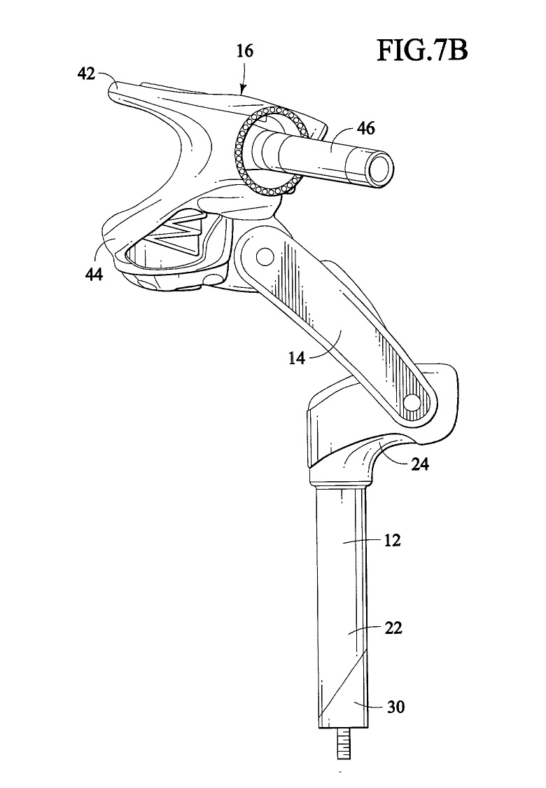

Distal end 24 of stem 12 is configured to be removably connected to the vehicle in at least two positions. In a first position as illustrated in FIG. 7A, distal end 24 projects forward translating extension 14 and integral support structure 16 forward. In a second position as illustrated in FIG. 7B, distal end projects rearward resulting in a rearward translation of the forwardly positioned extension 14 and integral support structure. As shown in FIGS. 7A and 7B, stem 12 allows rider to position extension 14 and structure 16 in a forward translated position or a rearward translated position thereby increasing the adjustable range of the system 10 available to the rider. System 10 is configured to adapt to the rider's stature and positioning needs. Quill 20 of stem 12 is configured to couple to the vehicle within an adjustable height range. In an exemplary embodiment, stem 12 has an adjustable height range of approximately 150 mm. In an exemplary embodiment, a quill cover 21 is connected to and substantially covers distal end 24 of stem 12. In an alternative exemplary embodiment, distal end 24 of stem upwardly projects along the longitudinal axis of quill 20.

Referring to FIGS. 5 and 6, extension 14 is at least one linkage. In an exemplary embodiment, the extension is comprised of juxtaposed first and second extensions 14, 15. First and second extensions 14, 15 includes a stem aperture 32, 34 at a first end and a support structure aperture 36, 38 at a second end. In an exemplary embodiment, stem aperture 32 and support structure aperture 36 are threaded to receive extension bolts 40. Extension bolt 40 connects first ends of first and second extensions 14, 15 to distal end 24 of stem 12. Extension bolt 40 couples second ends of first and second extensions 14, 15 to integral support structure 16. First and second extensions 14, 15 increase the adjustable range of system 10 by providing a wider adjustable range of motion of integral support structure 16 and thereby increasing the range of adjustment available to the user of the vehicle. First and second extensions 14, 15 are made of an impact modified, glass-filled nylon. First and second extensions 14, 15 can also be made of metal, aluminum, polymers, etc.

Integral support structure 16 an elongate member. In an exemplary embodiment, structure 16 includes a plurality of receptacles and mounting surfaces configured to integrally receive or integrally attach to the equipment. Equipment include accessories, controls and displays. Structure 16 further includes upper and lower spars 42, 44, and left and right mandrels 46, 48 outwardly projecting from left and right ends 50, 52 of structure 16. Lower spar 44 of structure 16 is coupled to first and second extensions 14, 15. Extension bolt 40 extends through second extension 15, a lower clamp 54 and connects to first extension 14. Lower clamp 54 has a planar, semi-circular shape with a plurality of apertures. Computer 18 is disposed onto lower clamp 54 and lower spar 44. An upper clamp 58 having a semi-annular shape and including a plurality of apertures is placed over computer 18. Clamp bolts 60 fasten structure 16 to first and second extensions 14, 15 and secure computer 18 between extensions 14, 15 and structure 16. In an exemplary embodiment, a clamp cover 62 made of elastomeric material is connected to and partially covers upper and lower clamps 54, 58, first and second extensions 14, 15 and integral support structure 16.

Integral support structure 16 is an injection molding made of impact modified, glass-filled nylon. In an exemplary embodiment, structure 16 is made of fifty percent (50%) glass nylon with elastomeric impact modifiers. During operation, the impact modified, glass-filled nylon material of structure 16 dampens vibration sensed by the rider when grasping structure 16. The vibration can be by road harshness and rotational movement of the vehicle's tires over a riding surface. In an alternative exemplary embodiment, structure 16 is made glass and carbon filled nylon. Structure 16 can also include short and long glass fibers. Structure 16 can also be made of metal, aluminum, polymers, etc. Structure 16 can also be made by compression molding, gas assist injection molding etc.

Integrated rider control system 10 is an integrated, modular and adjustable platform. System 10 provides a completely new vehicle defining aesthetic, enhances the ergonomic fit of the rider to the vehicle, enhances the ergonomic function and accessibility of the equipment, such as controls, accessories and displays, and provides upgradeability with modular, fully integrated controls, accessories and accessory controls.

I.A. Integral Support Structure

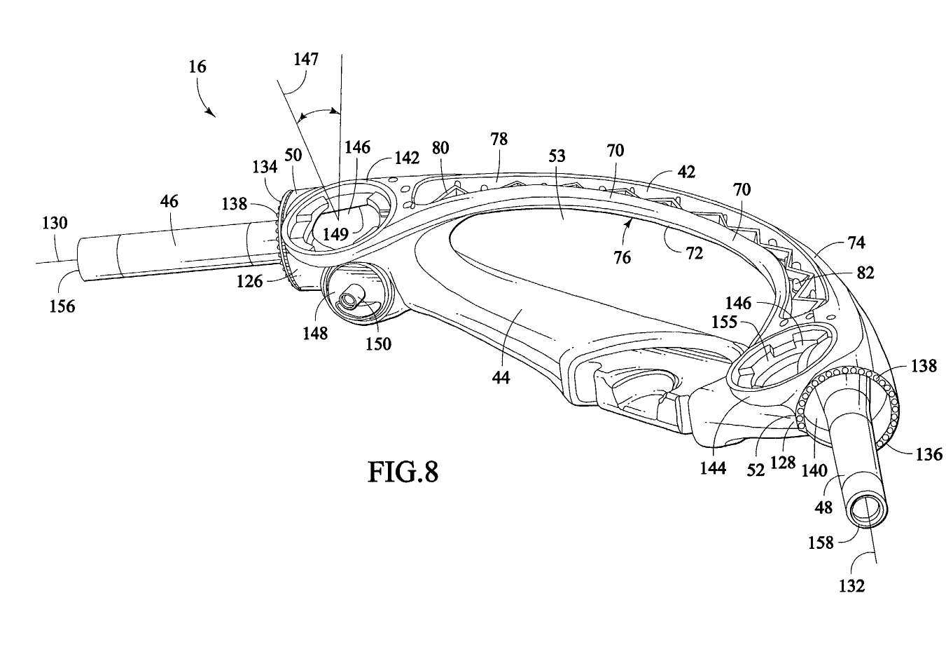

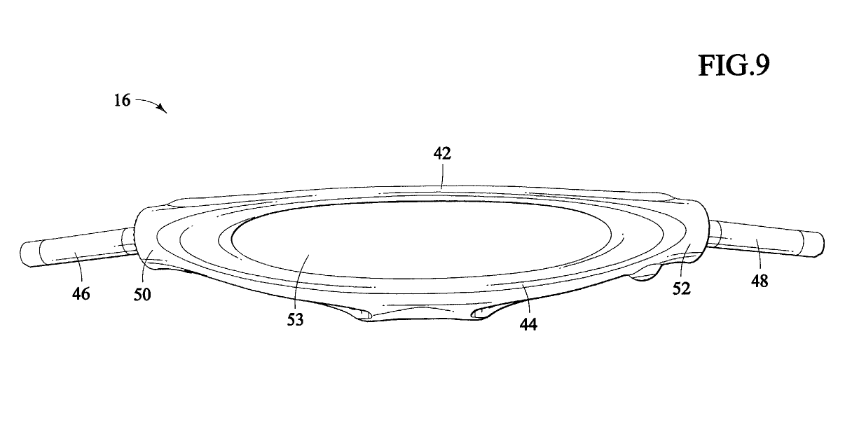

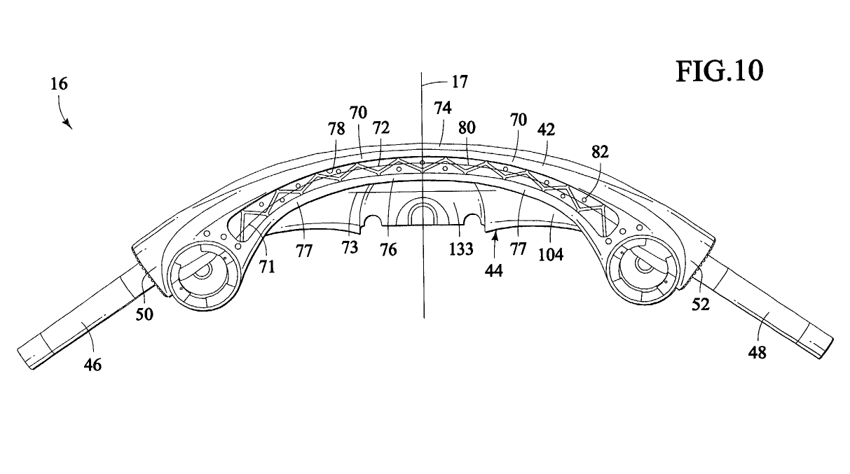

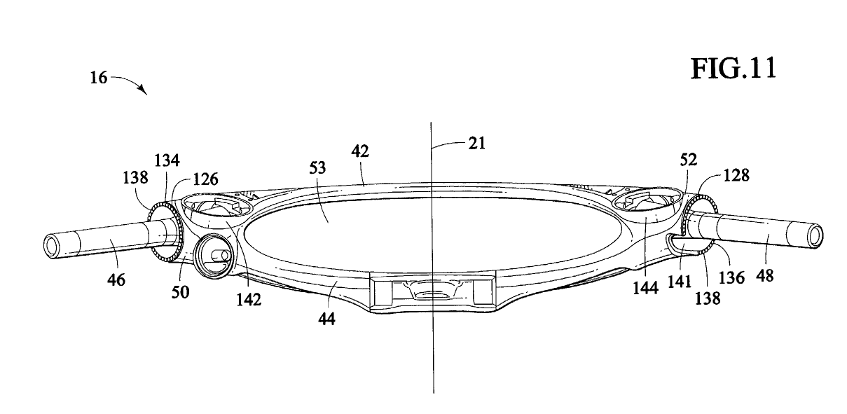

FIGS. 8 through 12 illustrate integral support structure 16 in greater detail. Referring to FIGS. 10 and 11, structure 16 is an elongate frame configured to transversely extend across a longitudinal centerline 17 of the vehicle. Structure 16 is substantially symmetrical about a vertical plane 21 extending through centerline 17 of the vehicle. Structure 16 is adapted to integrally support equipment for handle bar steered vehicle. Equipment include accessories, controls and displays. Structure 16 includes a plurality of receptacles and mounting surfaces configured to integrally receive or integrally attach to the equipment. The receptacles and mounting surfaces of structure 16 allow for the equipment to be integrally installed on to structure 16 with a plurality of different viewing aspects for the rider of the vehicle. In an exemplary embodiment illustrated in FIG. 9, structure 16 includes upper and lower spars 42, 44, left and right ends 50, 52, and left and right mandrels 46, 48. Upper and lower spars 42, 44 and left and right ends 50, 52 define an elongate oval opening 53.

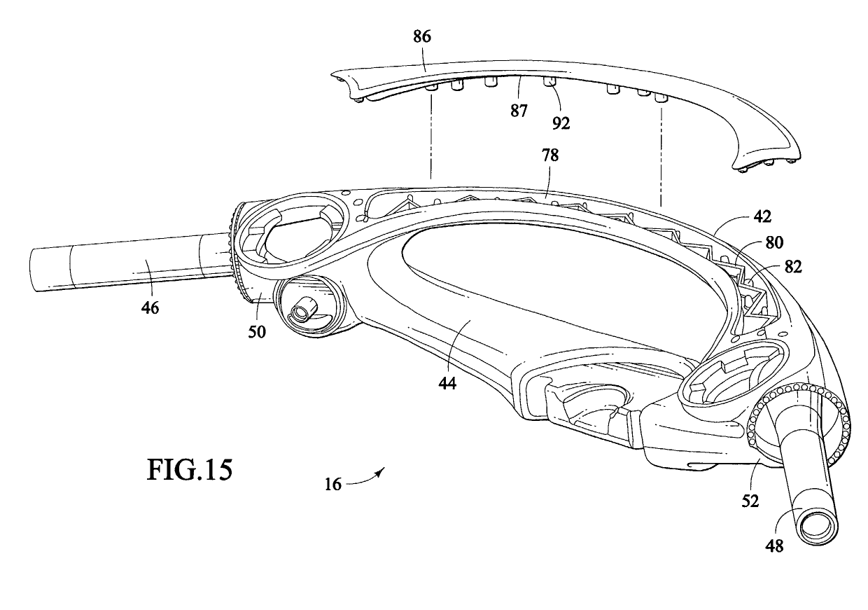

FIGS. 8 and 10 illustrate upper spar in greater detail. Upper spar 42 is a generally planar elongate member. Upper spar 42 is integrally formed between left and right ends 50, 52 and is substantially superimposed with lower spar 44. Upper spar 42 provides mounting surfaces and receptacles for the integral attachment of and the routing of cables between the equipment. Upper spar 42 is a substantially non-load bearing member in relation to lower spar 44. Upper spar 44 provides a secondary load bearing support to lower spar 44 of structure 16. Upper spar 42 includes gripping surfaces 70 configured for grasping by the user during operation of the vehicle. A lower planar surface 72 and front and rear side surfaces 74, 76 of upper spar 42 define an elongate channel 78 within upper spar 42. A plurality of interconnecting interconnected partition walls or trusses 80 and pins 82 upwardly extend from lower surface 72 of upper spar 42. Trusses 80 increase the strength of the upper spar and provide a location for attaching accessories. As best illustrated in FIGS. 10 and 15, pins 82 provide a fastening means for a cushionable cover 86. In an alternative exemplary embodiment, upper spar 42 includes a central boss configured to support computer 18.

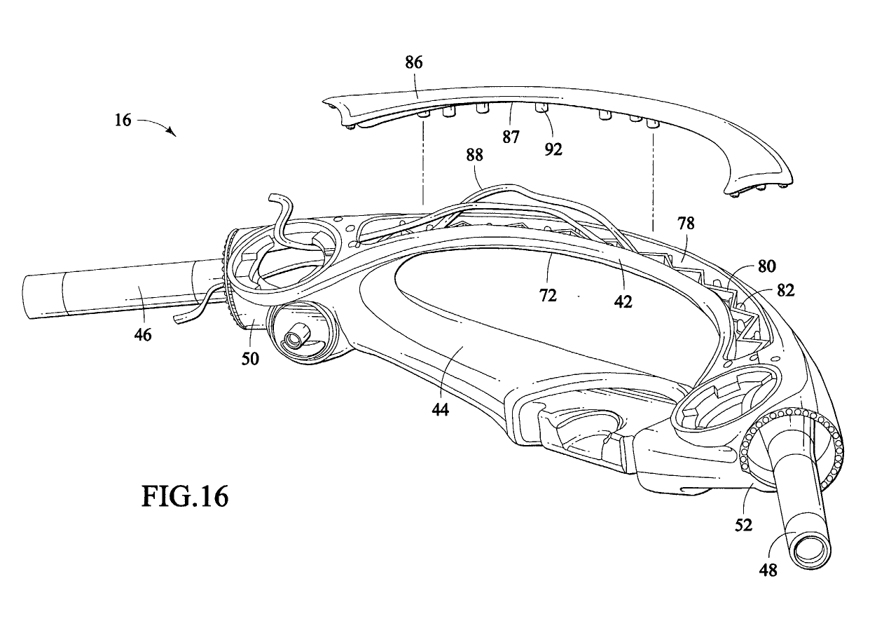

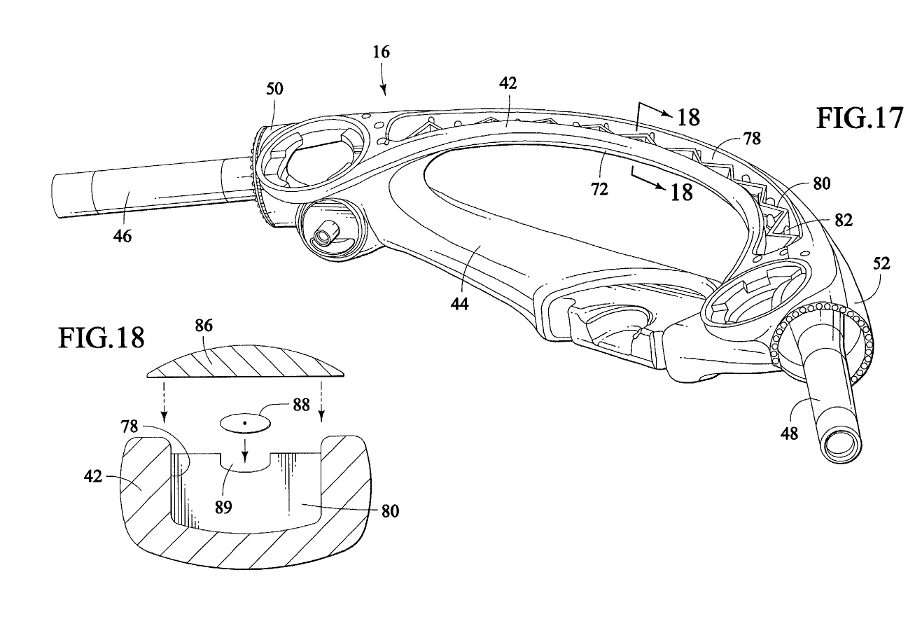

FIGS. 16 through 18 illustrates channel 78 in greater detail. Channel 78 provides a receptacle for integrally receiving at least one supplemental device. Channel 78 further provides a passage for the integral routing of at least one cable 88 between equipment within upper spar 42. In an exemplary embodiment illustrated in FIG. 18, a notch 89 is defined in a plurality of trusses 80 to accommodate cable 88. Cable 88 can include a housing and one or more wires. Cable 88 is integrally secured within upper spar 42 between notches 89 in trusses 80 and cushionable cover 86. In an alternative exemplary embodiment, as illustrated in FIG. 21, a hole 90 is defined in at least one truss 80 of upper or lower spar 42, 44 to accommodate cable 88. The cable routing methods described above allow structure 16 to be used for integrally attaching equipment and integrally routing cables 88 between the equipment. The integral routing of cables 88 eliminates or minimizes the risk of cables 88 becoming entangled with a foreign object or the rider. Additionally, the integral routing of cables prevents moisture and debris from contacting the integrally routed cables 88. In an alternative exemplary embodiment, upper spar 42 substantially hollow in construction and does not include trusses 80. In another alternative exemplary embodiment, upper spar 42 includes strengthen members having arcuate or irregular shapes. Additional holes can be drilled through lower surface 72 of upper spar 42 to facilitate integral fastening of the equipment to upper spar 42.

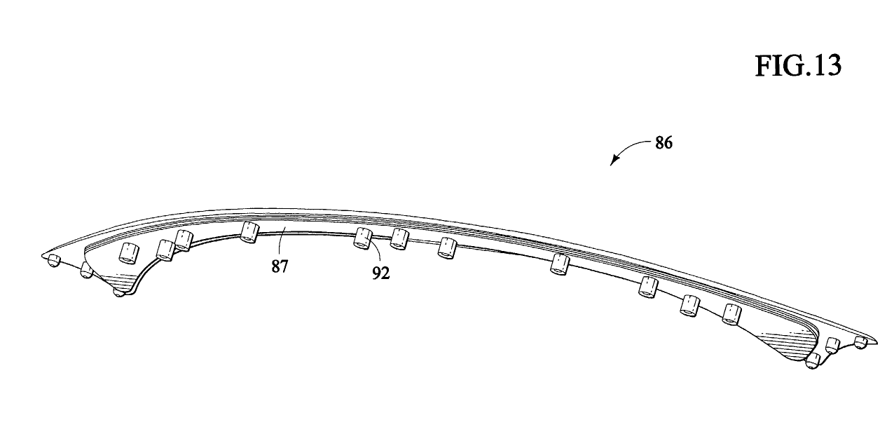

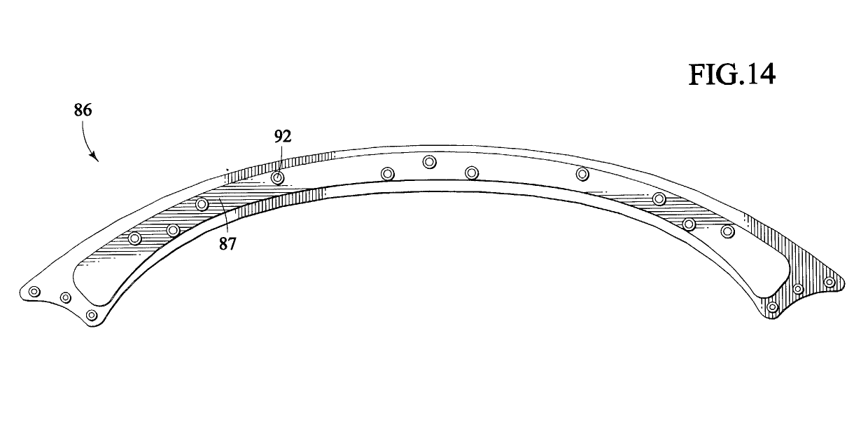

FIGS. 13 and 14 illustrate cushionable cover 86. Cushionable cover 86 is a flexible, elongate sheet of resilient, tactile material. The cushionable aspect of cover 86 is used to provide comfort to the rider's hands or to prevent harm to the rider upon impact. Cover 86 includes a lower surface 87 having a plurality of downwardly projecting bosses 92. Each boss 92 having a longitudinally extending bore. As illustrated in FIGS. 15 and 16, cover 86 connects to upper spar 42, substantially covering channel 78. Bosses 92 are configured to engage pins 82 and provide a removable friction fit of cover 86 to upper spar 42. As best shown in FIGS. 16 and 18, cover 86 facilitates the integral attachment of fasteners and cables 88 within upper spar 44. Cover 86 prevents moisture from entering channel 78 of upper spar 42 thereby protecting cables 88 and the fasteners. Cover 86 provides a smooth, tactile upper surface to upper spar 42. Cover 86 is made of an elastomeric, resilient material such as rubber. Alternatively, cover 86 can be made of other materials, such as plastic, etc. Cover 86 can be made in a variety of different colors to match the color scheme of the vehicle or other object. In an alternative embodiment, cushionable cover 86 can comprise multiple covers, can be modular and come in a variety of alternate shapes and sizes. Cover 86 provides a unique aesthetic to structure 16 and integrated rider control system 10.

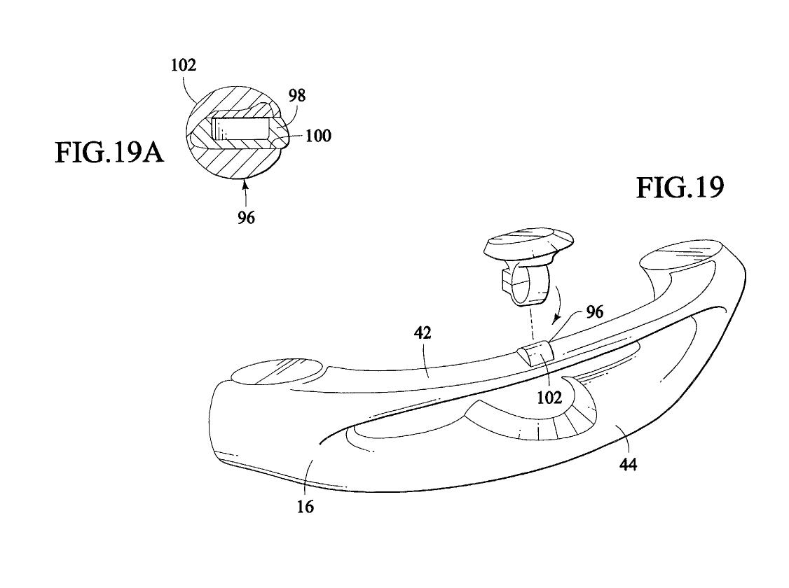

As illustrated in FIGS. 19A and 19B, upper spar 42 can also include a standard handlebar adapter 96. Adapter 96 is a ring. Adapter 96 is configured to removably connect to upper spar 42. Adapter 96 is made of a resilient material. Adapter 96 is configured to fit around upper spar 42 and to provide a secure cylindrical mounting surface equivalent to that of a standard cylindrical handlebar. Adapter 96 allows for conventional handlebar mounted accessories to be connected to structure 16. Adapter 96 includes a slot 98, an irregular inner surface 100 and a substantially cylindrical outer surface 102. Slot 98 is configured to resilient expand allowing adapter 96 to fit over upper spar 42. Irregular inner surface 100 is configured to substantially engage upper spar 42. Outer surface 102 is configured to replicate the shape and size of standard cylindrical handlebars. In an exemplary embodiment, adapter 96 is made in at least two sizes: 22.2 mm and 25.4 mm. In an alternative embodiment, adapter 96 can be a hinged device. In another alternative embodiment, adapter 96 comprises at least two arcuate parts coupled to form the adapter.

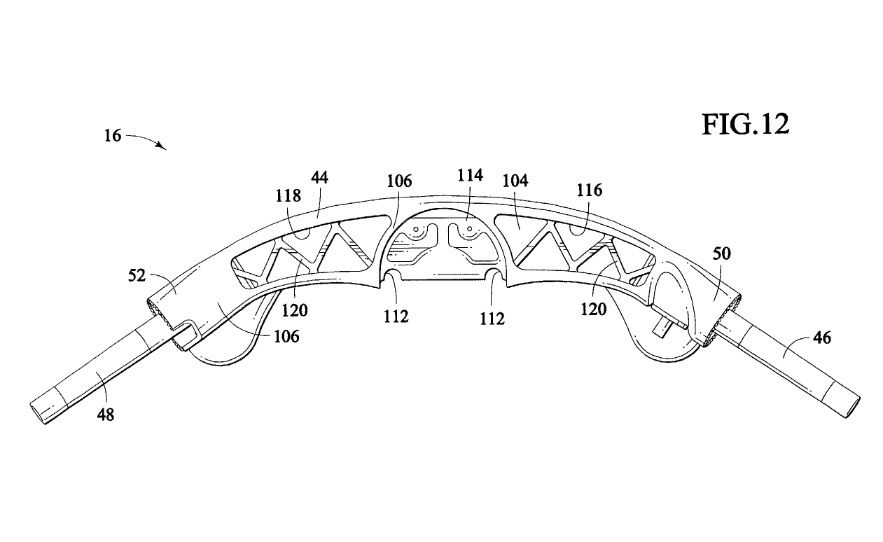

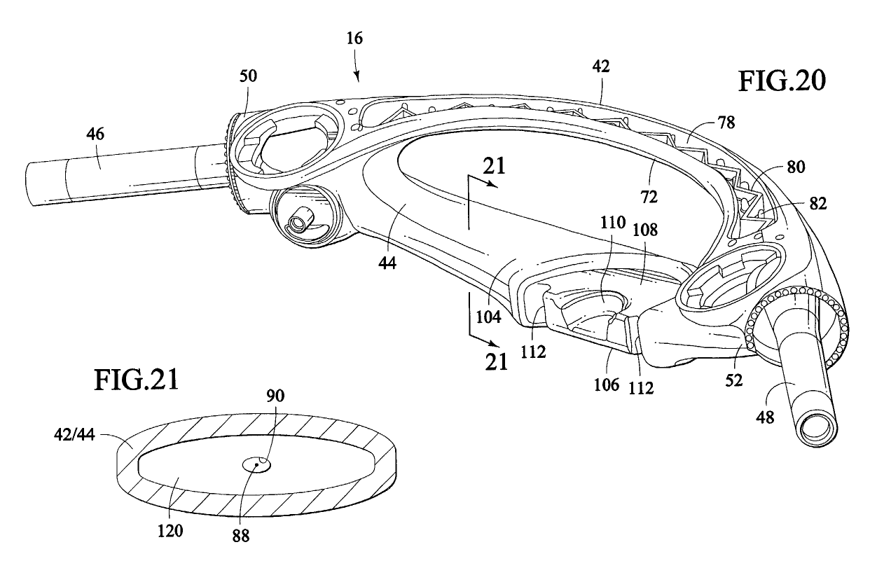

FIGS. 12 and 20 illustrate lower spar 44 in greater detail. Lower spar 44 is a generally planar elongate member having a generally planar upper surface 104 and an arcuate lower surface 106. Lower spar 44 is integrally formed between left and right ends 50, 52. Lower spar 44 is configured to couple to first and second extensions 14, 15. In operation, lower spar 44 is the primary load bearing member of structure 16. Upper surface 104 includes major and minor arcuate recesses 108, 110. Major and minor arcuate recesses 108 are configured to partially receive and support computer 18. A pair of slots 112 extend from upper surface 104 to lower surface 106 and are configured to accommodate clamp bolts 60 for the attachment of extensions 14, 15 to lower spar 44.

FIG. 12 illustrates lower surface 106 of lower spar 44 in greater detail. Lower surface 106 of lower spar 44 includes a lower semi-circular recess 114 configured to engage lower clamp 54. Left and right lower channels 116, 118 are defined into lower spar 44. Left and right lower channels 116, 118 are open at lower surface 106 and include a plurality of lower trusses 120 downwardly extending from upper surface 104 of lower spar 44. Lower trusses 120 strengthen lower spar 44.

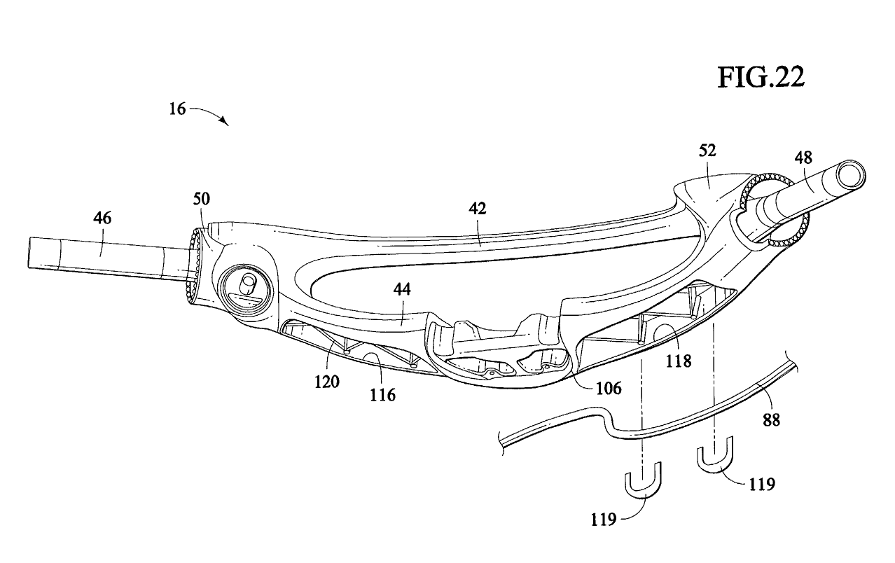

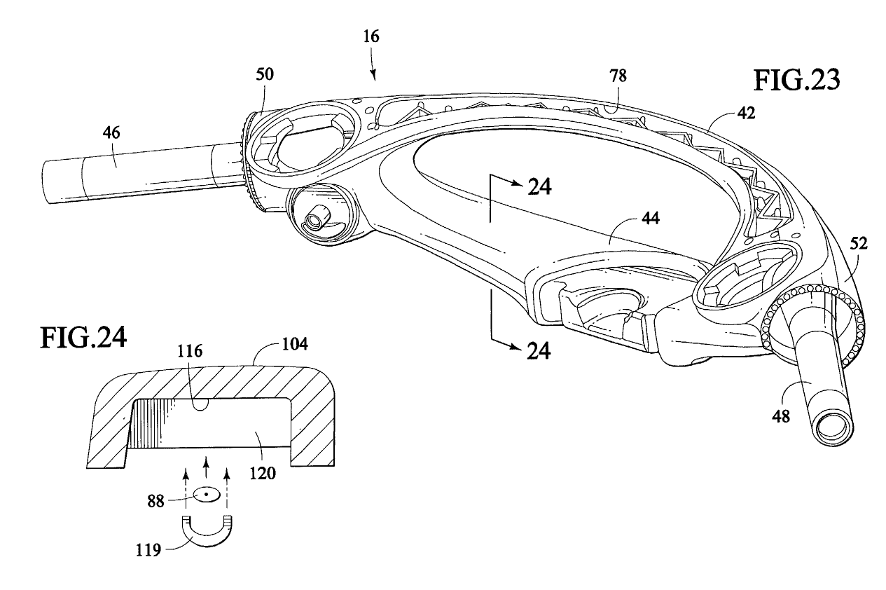

Left and right lower channels 116, 118 provide receptacles configured to integrally receive the equipment and cables 88. In one exemplary embodiment as illustrated in FIG. 21, a hole 90 is defined within at least one lower truss 120 to accommodate at least one cable 88. In an alternative exemplary embodiment as illustrated in FIGS. 22 through 24, cable 88 can be routed through one of left and right lower channels 116, 118 and secured within channels 116, 118 by at least one retaining clip 119 removably connected over cable 88 and to lower truss 120. The cable routing methods described above allow structure 16 to be used for integrally attaching equipment and integrally routing cables 88 between the equipment. The integral routing of cables 88 eliminates or minimizes the risk of cables 88 becoming entangled with a foreign object or the rider. Additionally, the integral routing of cables prevents moisture and debris from contacting the integrally routed cables 88. Additional holes can be defined through upper surface 104 of lower spar 44 into one of left and right lower channels 116, 118 to facilitate the integral fastening of the equipment to lower spar 44. In an alternative exemplary embodiment, lower spar 44 substantially hollow in construction and does not include lower trusses 120. In another alternative exemplary embodiment, lower spar 44 includes strengthen members having arcuate or irregular shapes.

FIG. 8 illustrates left and right ends 50, 52 in greater detail. Each left and right ends 50, 52 are integrally formed to upper and lower spars 42, 44 at one side and are integrally formed to left and right mandrels 46, 48 at an opposite side. Left and right ends 50, 52 include outwardly projecting left and right cylindrical sidewalls 126, 128, respectively, left and right bosses 142, 144, and a bell mounting surface 148 and projection 150.

As illustrated on FIG. 10, upper and lower spars 42, 44 each have an upper and a lower centerline 71, 73. Upper spar centerline 71 is positioned forward of the lower spar centerline 73. Upper spar 42 further includes a rear margin 77. Rear margin 77 is positioned such that the rider positioned in a typical semi-upright riding position can view upper surface 104 of lower spar. A typical riding position is one where the rider's torso is positioned in an upright position or in a forward bent or forward leaning position where the rider's eyes are positioned rearward and above structure 16. Upper spar 42 is positioned further forward than lower spar 44 such that upper spar 42 will not occlude the rider's vision of display or displays positioned on lower spar 44. When the hands of the rider grip the upper spar 42, the head of the rider will be closer to the lower spar 44 than would otherwise occur in single-tube handlebar systems.

Structure 16 includes a center section disposed between left and right ends 50, 52, the center section has upper spar 42, the upper spar is spaced above lower spar 44, a steering coupler (stem 12 and/or extension 14, 15) formed on the lower spar 44 couples structure 16 to the steering axis of the vehicle. A steering coupler 133 is formed on lower spar 44 for coupling the handlebar to the steering axis of the vehicle.

Structure 16 has an elongate body having left and right ends 50, 52, each adaptable to receive a handgrip 210. The body having a general surface, and at least one receptacle formed to extend inwardly from the general surface of the body at a location between the left and right ends, the receptacle is adapted to receive a predetermined piece of equipment selected from the group consisting of controls, displays and accessories such that the piece of equipment will be substantially flush mounted with respect to the general surface of the body.

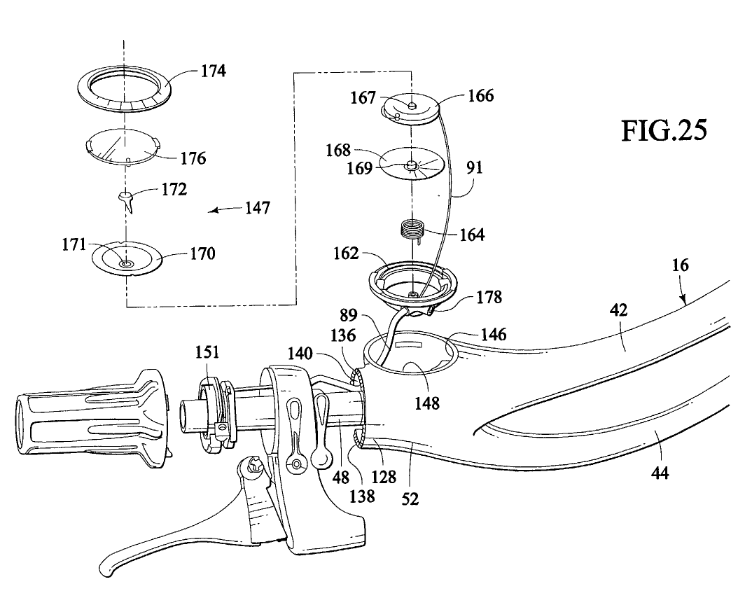

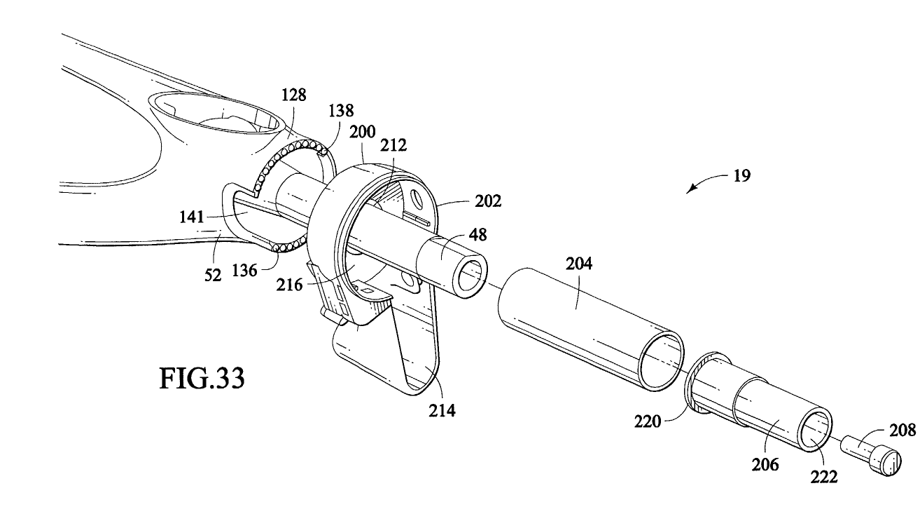

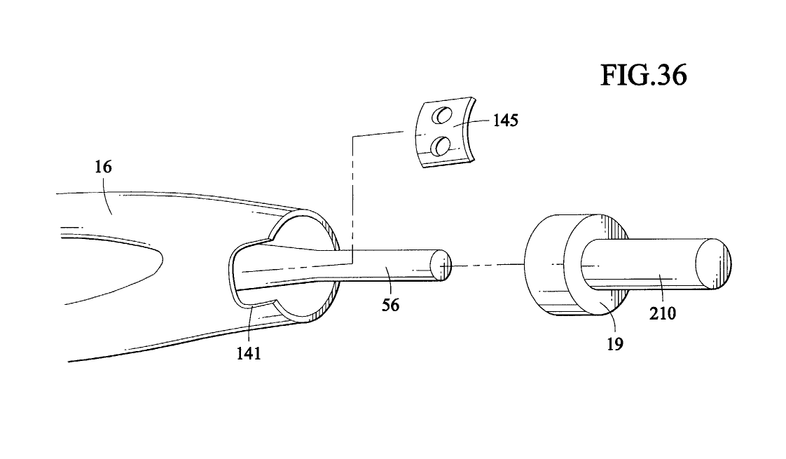

Left and right cylindrical sidewalls 126, 128 extend along an axis substantially parallel to a longitudinal axis 130, 132 of left and right mandrels 46, 48, respectively. Members 126, 128 can be formed of non-annular shapes, such as rectangular, oval, irregular, etc. Left and right edges 134, 136 of left and right mandrels, respectively, include a plurality of outwardly and axially projecting detents 138 extending substantially around the perimeter of left and right edges 134, 136. As illustrated on FIG. 25, cylindrical sidewalls 126, 128 are configured to contact a mandrel attachment. Mandrel attachments can include brake shifters, gear shifters, actuator grips, integrated brake gear shifters, brake grip assemblies, gear shifter grip assemblies and hand grips. In an exemplary embodiment, detents 138 of at least one cylindrical sidewall 126, 128 engage at least one mandrel attachment to facilitate rotational positioning of the mandrel attachment about the mandrel. When left and right cylindrical sidewalls 126, 128 each engage one mandrel attachment, detents 138 facilitate the rotational positional positioning of the mandrel attachment with respect to one another. In an alternative exemplary embodiment, detents 138 project radially and outwardly from left and right cylindrical sidewalls 126, 128. Each cylindrical sidewall 126, 128, each mandrel 46, 48 and structure 16 define a receiving cavity 140. Receiving cavity 140 is configured to partially receive the mandrel attachment. In an alternative exemplary embodiment, receiving cavity 140 receives at least one supplemental device. In an exemplary embodiment as best shown in FIGS. 33 and 36, at least one cylindrical sidewall 126, 128 includes a rectangular cutout 141 inwardly extending from edge 134, 136. Cutout 141 can have an alternative shape, such as oval, square, circular, etc. As illustrated in FIG. 36, cutout 141 is configured to integrally receive at least one supplemental device, such as a pushbutton control 145. FIG. 36 illustrates the location of control 145 within cutout 141. Control pod 19 can be positioned at the right end 52 to cover right end 145 and the right edge of control 145. Cutout 141 proceeds inward from edge 136 of the one of the cylindrical sidewalls 126, 128 toward the longitudinal centerline of the handlebar steered vehicle.

As best shown in FIG. 8, left and right bosses 142, 144 integrally extend from left and right ends 50, 52, respectively. Each boss 142, 144 includes an indication port 146. In an exemplary embodiment, as shown in FIG. 25, indication port 146 is a gear indication port and an opening 148 extends through structure 16 connecting indication port 146 with receiving cavity 140. The opening allows for passage of at least one cable housing 89 and at least one cable, such as an auxiliary gear cable 91. In an exemplary embodiment auxiliary gear cable 91 extends through gear indication port to receiving cavity 140 to connect a gear shifter 151 to a gear indication device 147 within gear indication port 146.

The axis 147 of port 146 is angled rearwardly and inboard from the vertical. Port 146 is formed in the body to be offset from the longitudinal axis of the handlebar-steered vehicle. A left port 149 or first display receptacle, is adapted. to receive a display to be viewed by the rider. The axis of left port 149 and a right port 155 are angled in an inboard and rearward direction with respect to a vertical reference. Right port 155 is a second display receptacle, and is positioned to the right of the longitudinal axis. Left port 149 is positioned to the left of the longitudinal axis.

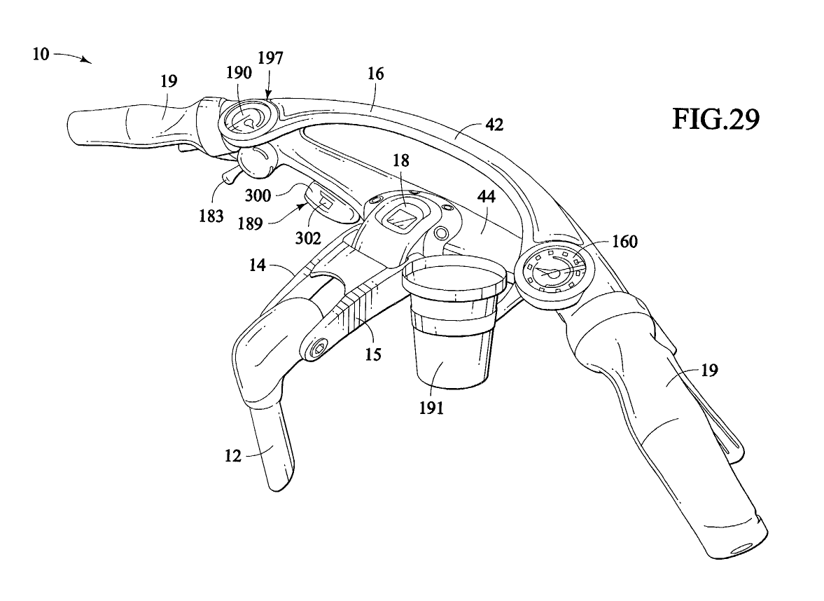

As illustrated on FIG. 8, left mandrel 46 includes a bell mounting surface 148 and a bell mounting projection 150. Bell mounting surface and projection 148, 150 allow for the integrated attachment of a bell 152 to structure 16 as shown on FIG. 29. Alternatively, other equipment can also be integrally attached to surface and projection 148, 150. In an alternative exemplary embodiment, surface and projection 148, 150 are disposed on either of or both left and right ends 50, 52.

FIG. 8 illustrates left and right mandrels 46, 48 in greater detail. Left and right mandrels 46, 48 are cylindrical tubes. Left and right mandrels 46, 48 are integrally formed to and extend from left and right ends 50, 52, respectively along left and right mandrel axes 130, 132. In an exemplary embodiment, left and right mandrels 50, 52 include internally threaded open ends, 156, 158, respectively, configured to receive a fastener. In an exemplary embodiment, the outer diameter of the left and right mandrels 50, 52 is less than or equal to 0.875 inches. The 0.875 inches or less outside diameter allows for an increased cable pull rate for spooling or twist actuators than conventional spooling or twist actuators in response to a specific angular translation of the spooling or twist actuator about an axis extending through the longitudinal axis of the mandrel. The reduced outside diameter and resulting increased pull rate reduces the amount of angular translation required by the user of the actuator in order to achieve the desired cable pull and to accomplish a desired result, for example, a shift from one gear to a second gear. Left and right mandrels 50, 52 provide gripping surfaces for the user and are configured for the attachment of a mandrel attachment. Mandrel attachments can include brake shifters, gear shifters, actuator grips, integrated brake gear shifters, brake grip assemblies, gear shifter grip assemblies and hand grips. In alternative exemplary embodiments, left and right mandrels 46, 48 can have alternative forms, such as tapered spindle, solid cylindrical or non-cylindrical bars, etc. In an alternative exemplary embodiment, left and right mandrels 46, 48 are coupled to first and second ends 50, 52, respectively, of structure 16 and can be made a different material than structure 16, such as metal, aluminum, polymer, etc.

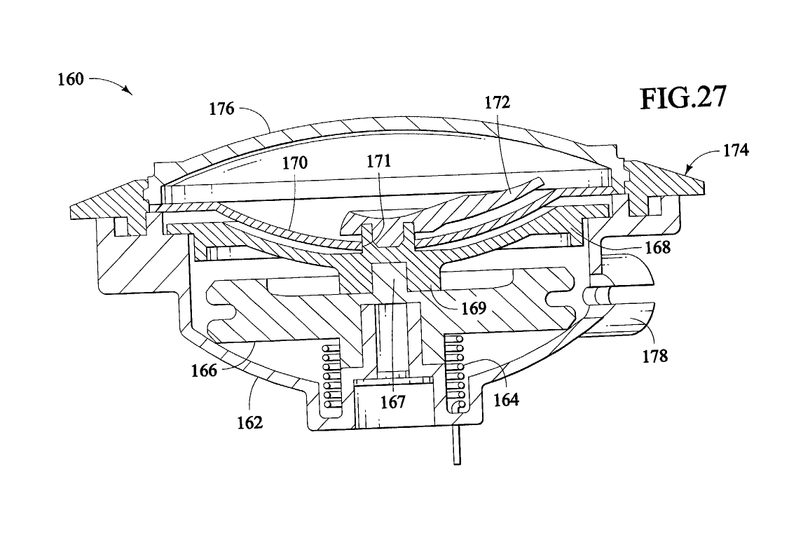

FIGS. 25 through 27 illustrate one exemplary embodiment of a gear indication device 147. Gear indication device 147 is a dial gear indicator 160. As shown in FIG. 25, dial gear indicator 160 is integrally disposed within at least one indication port 146 and is operably coupled to gear shifter 151 through an auxiliary gear cable 91. Dial gear indicator 160 displays positive indication of the existing position of the gear assembly to the rider. Dial gear indicator 160 positioned within the structure 16 to provide ergonomically optimal gear indication to the rider.

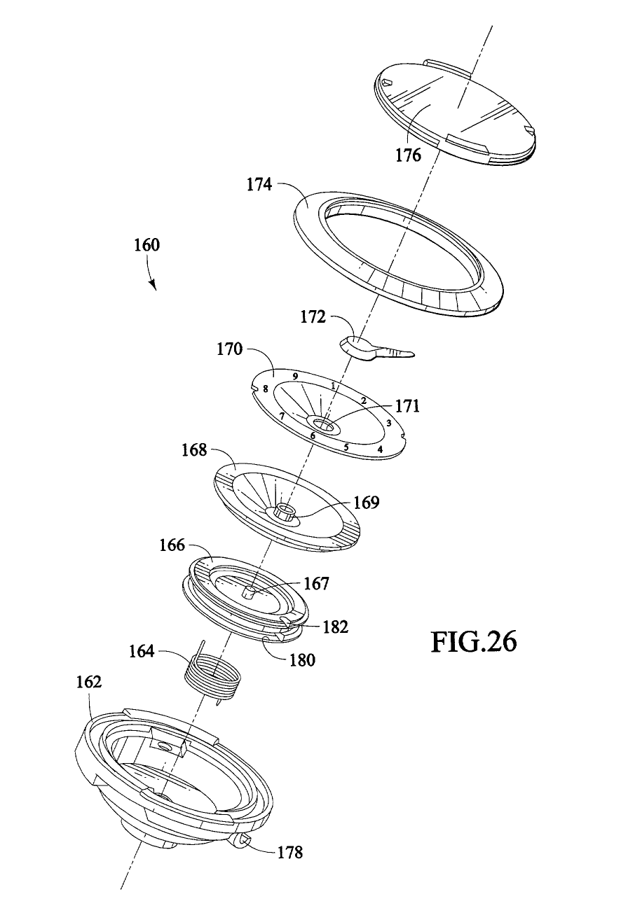

As best illustrated in FIG. 26, dial gear indicator 160 includes a bucket 162, a spring 164, a spool 166, an under-dial 168, a dial face 170, a needle 172, a lock ring 174, and a dome 176. Bucket 162 is a generally circular body having a radially extending gear cable passage 178. Bucket 162 is configured to hold the components of dial gear indicator 160. Spool 166 is a circular disk including an upstanding projection 167 upwardly extending from an upper surface of spool 166. Spool 166 has a gear cable slot 180 inwardly extending from the perimeter of spool 166 and a cable retention notch 182. Spool 166 rotatably connects to bucket 162. Spool 166 engages auxiliary gear cable 91 within dial gear indicator 160. Auxiliary gear cable 91 removable attaches to spool 166 at notch 182 and engages a portion of the perimeter of slot 180 of spool 166. Auxiliary gear cable 91 exits dial gear indicator 160 through passage 178 of bucket 162. Spring 164 is a biasing device connected to spool 166 at one end and bucket 162 at a second end. Spring biases spool 166 away from the upper surfaces of bucket 162 to facilitate rotational movement of spool 166. Under-dial 168 is a generally flat circular disk having a centrally positioned upwardly projecting hollow stub 169. Stub 169 is configured to engage the projection 167 of spool at a lower surface of under-dial 168. Under-dial 168 is configured for rotational movement with spool 166. Disk face 170 is a generally flat disk with a centrally positioned opening 171 and an upper surface with indicia representative of gear positions. Disk face 170 connects to an outer edge of bucket 162. Opening 171 is sized to allow stub 169 to extend through dial face 170. Needle 172 is a flat arrow shaped structure having a circular base. Needle 172 connects to stub 169 of under-dial 168. Needle 172 rotates along with spool 166 and under-dial 168. Lock ring 174 is a circular ring that secures to the outer edge of bucket 162. Dome 176 is a flat clear circular disk configured to removably attach to lock ring 174. Lock ring 174 and dome 176 retain gear dial indicator components in place. Dome 176 and lock ring 174 prevent moisture and debris from entering and interfering with the operation of dial gear indicator 160. Alternative dial gear configurations are contemplated, such as a dial gear configuration with a fixed dial and a rotating dial face.

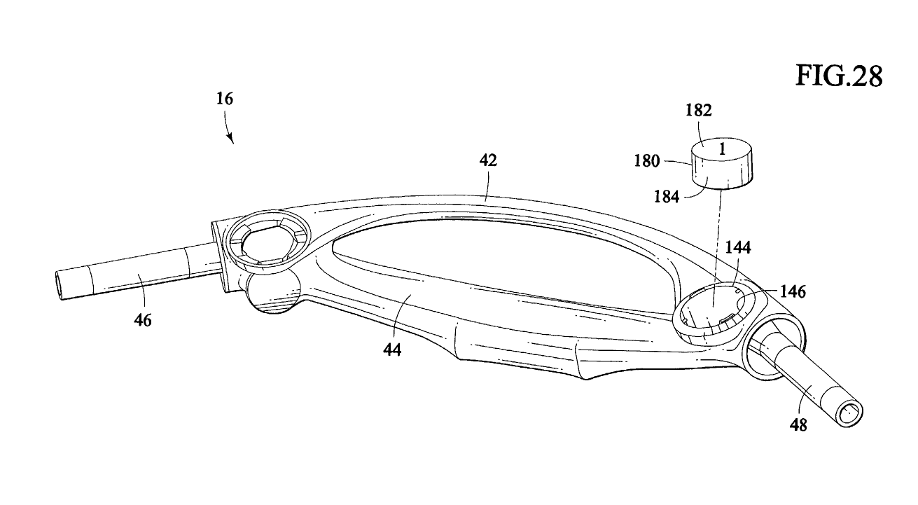

FIG. 28 illustrates one exemplary embodiment of the gear indication device. The gear indication device is an LED gear indication device 180. LED gear indication device 180 is integrally connected to structure 16 at indication port 146. LED gear indication device 180 includes a display screen 182 and a body 184. Display screen 182 displays the gear setting of the vehicle.

FIGS. 29, 30 and 31A through I illustrate examples of the equipment available for integral connection to structure 16. The use of structure 16 eliminates the need to attach equipment in a random, piece-meal, add-on basis. The use of structure 16 minimizes or eliminates exposed sharp metallic surfaces of the equipment and the fasteners for the equipment. Structure 16 encloses substantially encloses cables 88 extending between the equipment, thereby minimizing or eliminating the risk of cable entanglement with foreign objects. Structure 16 provides significantly larger amount of mounting surfaces and receptacles than conventional handlebar assemblies minimizing obstructions to the rider and encroachment into the rider's space during operation of the vehicle. The integral attachment of equipment provided by structure 16 significantly reduces the susceptibility of such devices to theft. Equipment include accessories, controls and displays. Accessories include, but are not limited to, a bell 183, a computer 18, a light 184, a basket 185, a horn 186, a reflector 187, a heart rate monitor 188, a garage door opener 189, a compass 190, an odometer, a cyclometer, a drink holder 191, a mirror 192, a radio holder 193, an alarm, a cell phone holder 194, a beeper holder 195, a lock holder 196, a global positioning system 197, an ash tray 198, a tool pack 199, key ring holder 201 and a combination thereof. Controls include, but are not limited to, levers, pushbuttons, switches, actuators, brake shifters, gear shifters, actuator grips, integrated brake gear shifters, brake grip assemblies, computers and gear shifter grip assemblies. Displays can include LED display devices, computer monitors, etc.

In an alternative embodiment, FIG. 32 shows a support structure 10 using a two-spar system where each spar is generally planar.

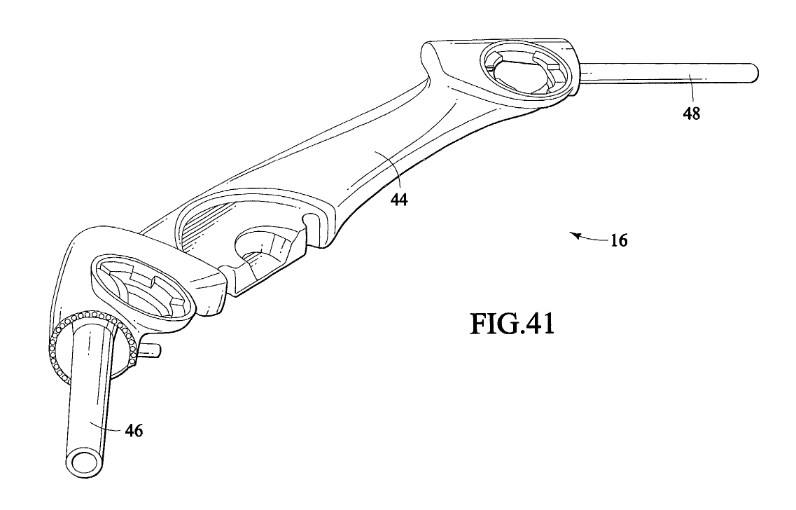

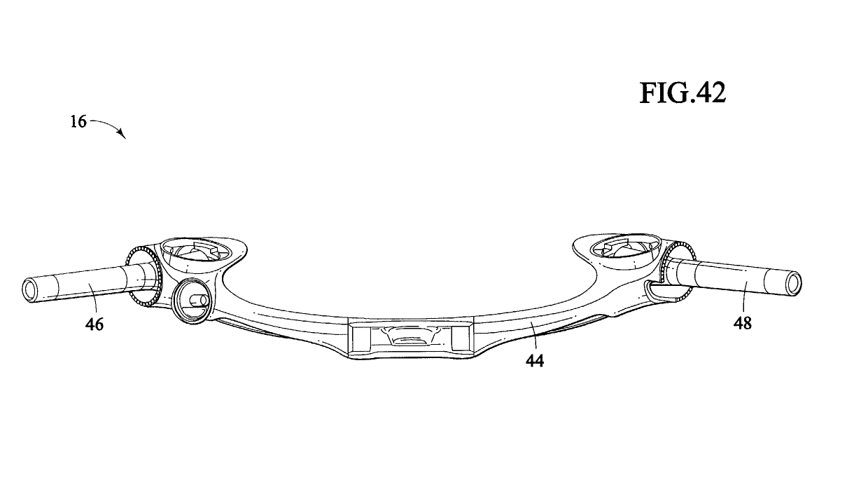

In another alternative exemplary embodiment, as shown in FIGS. 41 and 42, integral support structure 16 is an elongate single non-tubular spar structure. The single spar structure includes a plurality of mounting surfaces and receptacles configured to integrally attach and receive the equipment.

Modular Support Structure

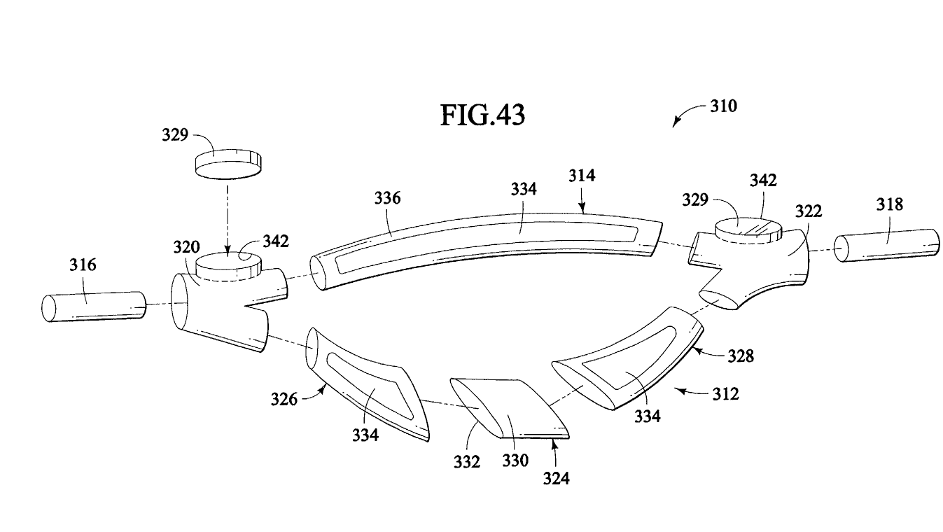

FIG. 43 illustrates a modular support structure 310. Modular support structure 310 includes a lower spar 312, an upper spar 314, left and right mandrels 316, 318 and left and right integration knuckles 320, 322. Lower spar 312 of modular support structure 310 is an elongate, non-tubular member. Lower spar 312 includes a central mounting member 324 and left and right lower spar wings 326, 328. Central mounting member 324 is a generally planar member having a generally planar upper clamping surface 330 and a lower surface 332. Central mounting member 324 is connected to left and right lower spar wings 326, 328. Central mounting member 324 is configured to couple to a pair of extensions (not shown) extending from a stem (not shown) of the handlebar steered vehicle. In an alternative embodiment, central mounting member 324 can connect directly to the stem of the vehicle. Central mounting member 324 is made of impact modified, glass-filled nylon. Alternative materials can be used such as, glass and carbon filled nylon, plastic, aluminum, metal, etc. Member 324 provides a centrally positioned, easily accessible support surface for equipment such as a computer. Member 324 provides a receiving receptacle for removably receiving the computer that is secure, aesthetically pleasing, and ergonomically positioned. In an exemplary embodiment, upper clamping surface 330 includes major and minor arcuate recesses configured to partially receive and support a computer or other equipment and a pair of slots extending from upper clamping surface 330 to lower surface 332 configured to accommodate fasteners. In an exemplary embodiment, member 324 can also include non-cylindrical or cylindrical receptacles integrated into member 324 for integrally receiving a piece of equipment, fasteners or at least one cable.

Left and right lower spar wings 326, 328 are elongate, generally planar members connected to and extending from central mounting member 324. In an exemplary embodiment, left and right lower spar wings 326, 328 are press fit to central mounting member 324. Other methods can be used for attaching left and right wings 326, 328 to central mounting member 324, such as, adhesives, fasteners, tongue and groove, etc. In an alternative exemplary embodiment, left and right wings 326, 328 are integrally formed to each other and have a slot, preferably an arcuate slot, defined within left and right wings 326, 328 for connecting to member 324. In operation, left and right wings 326, 328, when assembled with central mounting member 324, provide a primary load bearing member of modular support structure 310. Left and right wings 326, 328 are made of impact modified, glass-filled nylon. Alternative materials can be used such as, glass and carbon filled nylon, plastic, aluminum, metal, etc. In an exemplary embodiment, left and right wings 326, 328 can also include at least one non-cylindrical or cylindrical receptacle integrated into at least one of left and right wings 326, 328 for integrally receiving a piece of equipment or fasteners. In another alternative exemplary embodiment, each left and right wings 326, 328 includes at least one cable passage extending within wings 326, 328. The internal routing of cables—31—within wings 326, 328 eliminates the risk of the cables becoming entangled with a foreign object or a rider, prevents moisture and debris from contacting the cables and improves the aesthetic appeal of structure 310.

Left and right wings 326, 328 each include a cushionable member 334 removably attached to an upper surface of left and right wings 326, 328. Cushionable member 334 can be used to cover receptacles and open passages within left and right wings 326, 328. Cushionable member 334 can be made in a variety of different shapes and colors. Cushionable member 334 is made of an elastomeric, resilient material, such as rubber. Alternatively, cushionable member 334 can be made of other materials, such as plastic, etc.

In an alternative exemplary embodiment, member 324 is integrally formed to left and right lower spar wings 326, 328. In another alternative embodiment, central mounting member is a generally semi-circular mounting disk coupled to a semi-circular slot formed by left and right lower spar wings.

Upper spar 314 is an elongate member. Upper spar 314 can have a different shapes, such as planar, tubular, etc. Upper spar 314 is connected to left and right integration knuckles 320, 322. Alternatively, upper spar 314 can be connected to other components, such as lower spar 312, left and right mandrels 316, 318, etc. Upper spar 314 is substantially superimposed over lower spar 312. In an exemplary embodiment, upper spar 314 is superimposed over the forward portion of lower spar 312 to increase the visibility of lower spar 312 to the rider positioned in a conventional operating position. Upper spar 314 is a substantially non-load bearing member and provides a secondary load bearing support to lower spar 312. Upper spar 314 includes cushionable member 334 removably attached to an upper surface of upper spar 314. Upper spar 314 also provides additional gripping surfaces 336 for grasping by the user during operation of the vehicle. In an alternative exemplary embodiment, one of a receiving receptacle and a channel is defined within upper spar 314 to accommodate fasteners, cables and equipment.

Left and right mandrels 316, 318 are tubular members. Left and right mandrels are connected to left and right integration knuckles 320, 322, respectively. Alternatively, left and right mandrels 316, 318 can be connected to upper spar 314, lower spar 312, or both upper and lower spars 316, 318. Left and right mandrels 316, 318 provide gripping surfaces for modular support structure 310 and support surfaces for a large number of mandrel attachments. Mandrel attachments can include brake shifters, gear shifters, actuator grips, integrated brake gear shifters, brake grip assemblies, gear shifter grip assemblies and hand grips. Left and right mandrels 316, 318 are made of impact modified, glass-filled nylon. Alternative materials can be used such as, glass and carbon filled nylon, plastic, aluminum, metal, etc. In an exemplary embodiment, the outer diameter of left and right mandrels 316, 318 is less than or equal to 0.875 inches. The 0.875 inches or less outside diameter allows for an increased cable pull rate for spooling or twist actuators than conventional spooling or twist actuators in response to a specific angular translation of the spooling or twist actuator about an axis extending through the longitudinal axis of the mandrel. The reduced outside diameter and resulting increased pull rate reduces the amount of angular translation and force required to be applied by the user of the actuator in order to achieve the desired cable pull and to accomplish a desired result, for example, a shift from one gear to a second gear. In an alternative exemplary embodiment, left and right mandrels 316, 318 each include an internally threaded open end for receiving a single fastener thereby accommodating single fastener connection of the mandrel attachment to left or right mandrels 316, 318. In another alternative embodiment, left and right mandrels 316, 318 can have alternative forms, such as a tapered spindle, a solid cylindrical bar, a non-tubular bar, etc.

Left and right integration knuckles 320, 322 are receiving structures. Left and right integration knuckles 320, 322 are coupled to lower spar 312, upper spar 314 and left and right mandrels 316, 318. In an alternative exemplary embodiment, integration knuckles 320, 322 are integrally connected to at least one of lower spar 312, upper spar 314 and left and right mandrels 316, 318. Left and right integration knuckles 320, 322 include at least one integrated instrument receiving receptacle 342. Receptacle 342 is sized to integrally receive a piece of equipment 329, such as a display, an accessory or a control. Left and right integration knuckles 320, 322 provide a junction for modular support structure 310. Left and right integration knuckles 320, 322 are preferably made of impact modified, glass-filled nylon. Alternative materials can be used such as glass and carbon filled nylon, plastic, aluminum, metal, etc. In an exemplary embodiment, equipment is substantially flush mounted with respect to the general surface of receptacle pod 320, 322. In another exemplary embodiment, an axis of the receptacle is angled in an inboard and rearward direction with respect to a vertical reference to facilitate viewing of the piece of equipment within receptacle 342 by the rider.

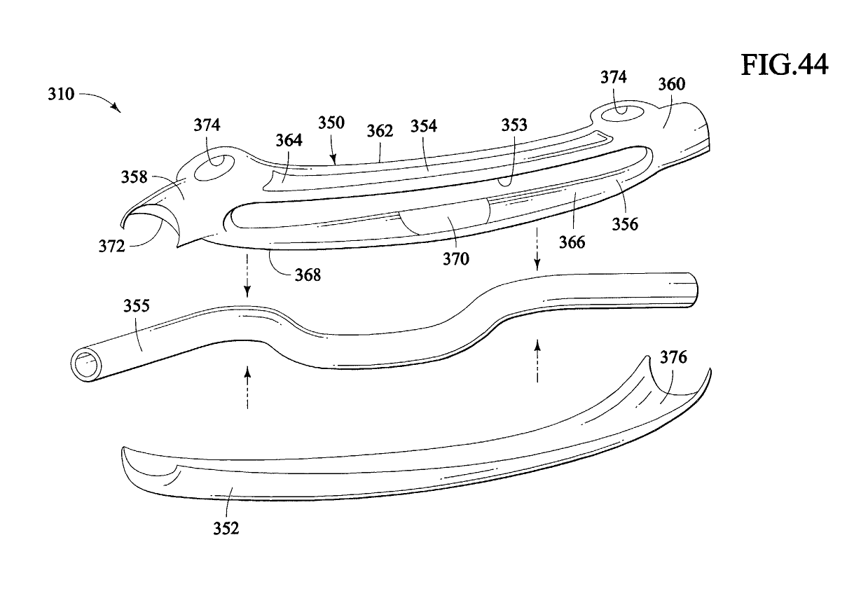

FIG. 44 illustrates an alternative exemplary embodiment of modular support structure 310. Modular support structure 310 is made of impact modified, glass-filled nylon. Alternative materials, or a combination of materials, can be used such as, glass and carbon filled nylon, plastic, aluminum, metal, etc. Modular support structure 310 includes upper and lower shells 350, 352. Upper shell 350 is an elongate member having an elongate oval opening 353. Upper shell 350 removably connects to one of lower shell 352 and a tubular handlebar 355. In an exemplary embodiment, upper shell 350 can connect to one of lower shell and handlebar assembly 355 by fasteners. Alternative methods for attaching upper shell 350 to one of lower shell 352 and handlebar assembly 355 can be used, such as, adhesives, snap-fit, tongue and groove, etc. Upper shell 350 includes an upper spar 354, a lower spar 356 and left and right upper end segments 358, 360.

Upper spar 354 is a generally planar elongate member. Upper spar 354 is integrally formed between left and right upper end segments 358, 360 and is substantially superimposed with lower spar 356. Upper spar 354 provides mounting surfaces and receptacles for the integral attachment of and the routing of cables between the equipment. Upper spar 354 includes a cushionable cover 364. Cushionable cover 364 is an elongate sheet of resilient, tactile material and is removably connected to upper spar 354. In an exemplary embodiment, cushionable cover 364 is equivalent to cushionable cover 86 described below in Section III. Upper spar 354 further includes gripping surfaces 362 configured for grasping by the user during operation of the vehicle.

Lower spar 356 is a generally planar elongate member having a generally planar upper surface 366 and a lower surface 368. Lower spar 356 is integrally formed between left and right upper end segments 358, 360. Lower spar 356 includes a recess 370 configured for supporting and partially receiving a piece of equipment, such as a computer. Lower surface 368 has substantially semi-cylindrical contour (not shown) configured for removably connecting to one of lower shell 352 and handlebar assembly 355.

Left and right upper end segments 358, 360 are integrally formed to upper and lower spars 354, 356. Left and right segments 358, 360 have a generally semi-cylindrical underside 372 and a receiving receptacle 374. Underside 372 of left and right upper end segments 358, 360 is configured for removably connecting to one of lower shell 352 and handlebar assembly 355. Handlebar assembly 355 outwardly extends beyond left and right segments 358, 360. Receiving receptacle 374 is configured to integrally receive a piece of equipment, such as a display or an accessory, fasteners or at least one cable. In an exemplary embodiment, the piece of equipment is flush mounted with respect to an outer surface of one of left and right segments 358, 360. In an exemplary embodiment, an axis of receptacle 374 is angled inboard and rearward to make receptacle 374 more visible to the rider positioned in a conventional operating position.

Lower shell 352 is an elongate member. Lower shell has a generally semi-cylindrical upper side 376 configured for removably connecting to one of upper shell 350 and handlebar assembly 355. In an exemplary embodiment, lower shell can include a receiving receptacle and a channel for receiving and supporting a piece of equipment, fasteners or cables.

In an alternative exemplary embodiment, the lower shell can include upper and lower spars and left and right lower end segments, where the upper spar is configured to connect to the underside of the handlebar assembly, and the upper shell can be a generally planar member configured to cover the top of the handlebar assembly.

III. Handlebar Assembly having a Cushionable Cover

FIGS. 13 through 16 illustrate a handlebar assembly for a handlebar steered vehicle, shown as integral support structure 16, having cushionable cover 86. Cushionable cover 86 is a flexible, elongate sheet of resilient, tactile material. Cover 86 connects to structure 18. In an exemplary embodiment, cover 86 can substantially cover channel 78. Cover 86 includes a lower surface having a plurality of downwardly projecting bosses 92. Each boss 92 having an longitudinal bore. Bosses 92 are configured to engage pins 82 and provide a removable friction fit of cover 86 to structure 16. In an alternative exemplary embodiment, cover 86 has a generally flat lower surface configured to attach to a generally flat surface of the handlebar assembly. Cover 86 facilitates the integral attachment of fasteners and cables 88 within structure 16. Cover 86 can be used to shield the rider of the vehicle from sharp metal surfaces and hardware of fasteners and prevent cables 88 from dangling beyond structure 16 and becoming entangled with foreign objects. Cover 86 can be used to prevent moisture from entering openings and recesses positioned beneath cover 86. Cover 86 provides a smooth, tactile upper surface and an aesthetically pleasing appearance to structure 16. Cover 86 is made of an elastomeric, resilient material such as rubber. Cover 86 can also be made of alternate materials, such as plastic, etc. Cover 86 can be made in a variety of different colors to match the color scheme of the vehicle or other object. In an alternative embodiment, cushionable cover 86 can be made in a variety of different shapes and sizes to match any handlebar assembly or rider control device for handlebar steered vehicles.

IV. An Integrated Mandrel Mounted Actuation Device (Control Pod) for Bicycles

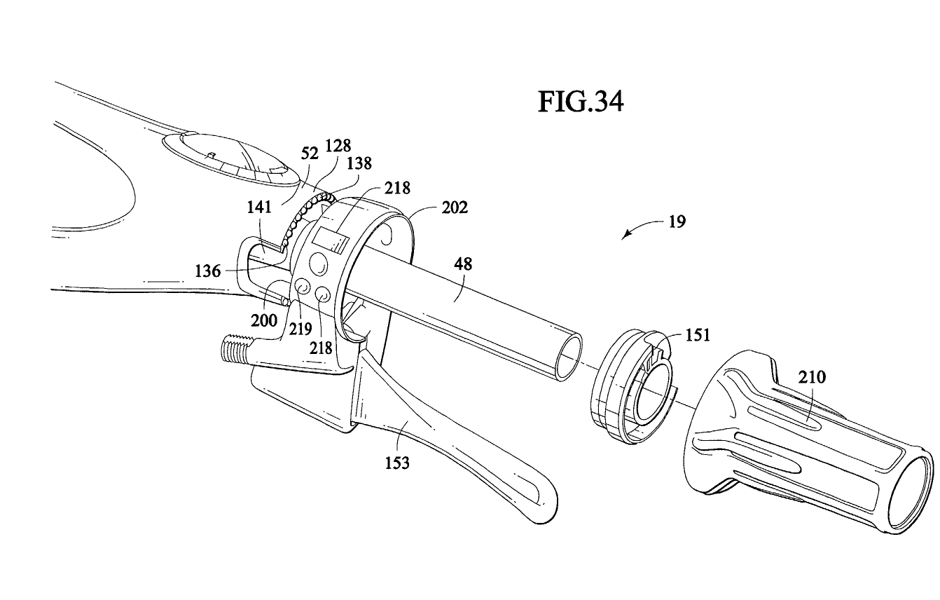

FIGS. 2 through 4 illustrate an integrated mandrel, or hand grip mount, mounted actuation device, shown as control pod 19. FIGS. 33 and 34, illustrate control pod 19 in greater detail. Control pod 19 is configured to axially connect to mandrel 46, 48, or a grip mount, of a handlebar assembly or a rider control device, shown as integral support structure 16. Control pod 19 includes a positioning surface 200 configured to extend in a plane that is substantially perpendicular to longitudinal axis of mandrel 46, 48. Positioning surface 200 of pod 19 is configured to contact the left or right ends 50, 52 of structure 16 when pod 19 is installed over left or right mandrel 46, 48. In an alternative exemplary embodiment, positioning surface 200 is configured to contact a stop attached to the handlebar assembly or the rider control device. Control pod 19 integrates the handgrip, actuation devices, and controls into an assembly configured to quickly and easily attach to mandrel 46, 48 of structure 16. In particular, control pod 19 integrates controls and actuators in a position within reach of the rider's hand without requiring the rider to remove his hand from structure 16 in order to actuate the controls or the actuators.

In an exemplary embodiment, as illustrated in FIG. 33, control pod 19 includes a pod housing 202, an intermediate tube 204, an axial fixture 206, actuating devices, and a fastener 208. Pod housing 202 is configured to slidably and axially mount to left or right mandrel 46, 48, or grip mount. Pod housing 202 is a housing having a mandrel opening 212, a brake lever region 214, and a gear shifter region 216. Mandrel opening 212 is a generally circular opening configured to allow mandrel 46, 48 to extend therethrough. Gear shifter region 216 is an upper region of pod housing 202 shaped to substantially enclose and conform to gear shifter 151. Brake lever region 214 is a lower region of pod housing 202 shaped to partially enclose brake lever 153. As shown in FIG. 34, pod housing 202 further includes control openings 218 are configured to accommodate controls. Pod housing encompasses and protects gear shifter 151, brake lever 153 and the controls from contact with foreign objects. Pod housing 202 is made of a plastic material. Alternative pod housing materials can be used such as nylon, aluminum, etc.

Referring to FIG. 33, intermediate tube 204 is a spacer tube configured to slidably extend over mandrel 46, 48 and to contact housing 202 at one end. Axial fixture 206 is a tube having a flanged end 220 and a fastener end 222. Fixture 206 is configured to extend over mandrel 46, 48 and contact intermediate tube 204 at flanged end 220. Fastener 208 extends through fastener end 222 of fixture 206 and engages threaded inner surface of mandrel 46, 48. As fastener 208 fastens to mandrel 46, 48, fastener 208 transmits force to fixture 206. Flanged end 220 of fixture 206 transmits the force to intermediate tube 204. Intermediate spacer 204 transmits the force to pod housing 202 causing pod housing to contact structure 16, or alternatively, the stop of the handlebar assembly. Fastener 208 secures pod housing 202, intermediate tube 204 and fixture 206 to one of left and right mandrels 46, 48.

As illustrated in FIG. 34, actuating devices, such as gear shifter 151 and brake lever 153, are attached to housing 202. Control devices 219 can also be inserted within housing 202 at control openings 218 of housing 202. A handgrip 210 is configured to slidably and removably fit over fixture 206 and contact outside edge of pod housing 202. In an exemplary embodiment, as illustrated in FIGS. 2 through 4, structure 16, housing 202 and grip 210 form a substantially continuous outer surface outline. In an alternative exemplary embodiment, control pod 19 is integrally and removably installed to left or right mandrels 46, 48 as a complete assembly. Control pod 19 can be adapted to contain a variety of different combinations of controls.

In an exemplary embodiment as illustrated in FIG. 34, ends 50, 52 include cylindrical sidewalls 126, 128 extending along an axis substantially parallel to a longitudinal axis 130, 132 of mandrels 46, 48, respectively. Edges 134, 136 of cylindrical sidewalls 126, 128, respectively, include a plurality of outwardly and axially projecting detents 138 extending substantially around the perimeter of edges 134, 136. Cylindrical sidewalls 126, 128 are configured to contact positioning end 200 of pod housing 202. In an exemplary embodiment, detents 138 of at least one cylindrical sidewall 126, 128 engage positioning end 200 of pod housing 202 to facilitate rotational positioning of control pod 19 about the mandrel. When left and right cylindrical sidewalls 126, 128 each engage one positioning end 200 of one pod housing 202, detents 138 facilitate the discrete rotational positioning of the control pods 19 with respect to one another. Detents 138 of left and right cylindrical sidewalls 126, 128 allow for the user to quickly and easily adjust and align control pods 19 positioned on left and right ends 50, 52 of the handlebar assembly or the integral rider control device. The integration and ergonomic positioning of controls and actuators with gripping surfaces of control pod 19 increases the rider's ability to control the vehicle.

V. A Control Assembly for a Bicycle Handlebar Assembly

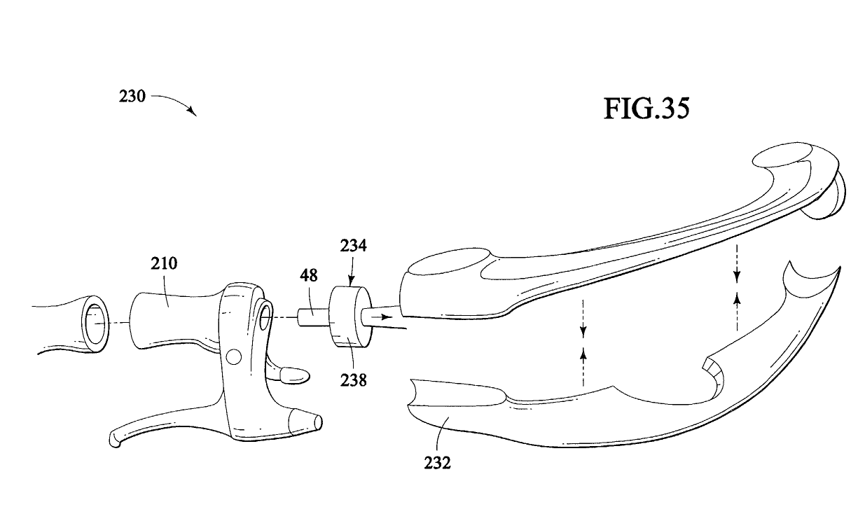

FIG. 35 illustrates a control assembly 230. Control assembly 230 includes a stop 232, a control ring 234, and a handgrip assembly 236. Stop 232 is a projection or boss integrally formed to or attached to a handlebar assembly or a rider control device. Either of the handlebar assembly and the rider control device are positioned at the forward end of the bicycle, are pivotally coupled to bicycle about a steering axis of the bicycle, and include left and right mandrels 46, 48, or left and right grip mounts, transversely extending from the longitudinal axis of the bicycle. Stop 232 is configured to prevent movement of control ring 234 further up or along the handlebar assembly or the rider control device past stop 232.

Control ring 234 is a device having a generally circular shape integrating equipment such as bicycle controls, accessories, displays, or any combination thereof. Control ring 234 can be configured in alternative shapes, such as rectangular, irregular, etc. Control ring 234 is configured to couple to the handlebar assembly or the rider control device. In an exemplary embodiment, control ring 234 slidably and axially mounts to left or right mandrel 46, 48 of handlebar assembly or rider control device and is positioned adjacent to stop 232. In alternative exemplary embodiment, the control ring includes a hinge or a slot allowing for non-axial attachment of the control ring to the handlebar assembly or the rider control device. In another alternative embodiment, the control ring is comprised of at least two pieces that are fastened together about the handlebar assembly or the rider control device. Control ring 234 includes a housing 238 and at least one control, accessory, or display device. Handgrip 210 is axially and slidably attached to left or right mandrel 46, 48 and is positioned adjacent to control device 234 at a side of control device 234 opposite of stop 232. Handgrip 210 prevents the movement of control device 234 along or down left or right mandrel 46, 48 or the grip mount. In an exemplary embodiment, handgrip 210 is an integrated brake shifter. Alternative handgrip configurations are contemplated. In an alternative embodiment, control ring 234 is coupled to a rider control device having a “shell” structure. The mandrel or grip mount is removably inserted into one or both of the control ring and the rider control device.

VI. A Rider Control System for a Bicycle having an Extended Range of Adjustment

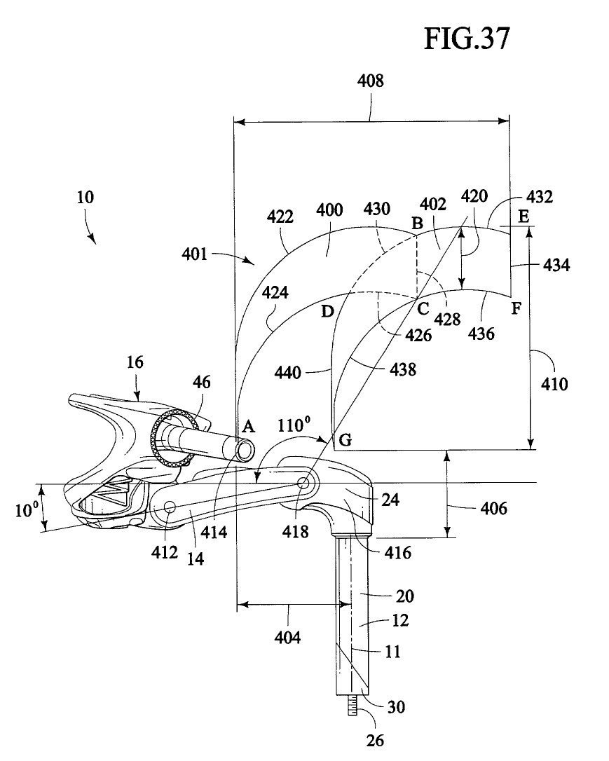

FIG. 37 illustrates the range of adjustability of integrated rider control system 10. Stem 12 is an elongate member having a distal end or head 24 projecting forward toward integral support structure 16. When the front wheel of the bicycle is straight, structure 16 is transversely positioned with respect to the longitudinal axis of the bicycle. Left and right extensions 14, 15 (only 14 is shown) pivot about a transversely extending stem extension axis 418 and a transversely extending support structure/extension axis 412. In an exemplary embodiment a lower surface of structure 16 is positionable about stem extension axis 418 from a negative 10 degrees to a positive 110 degrees with respect to a horizontal plane extending through the stem extension axis 418. Horizontal reference range 404 is the range of possible horizontal distances between steering axis 11 (the centerline of quill 20) to forward end point 414 of left mandrel 46 of structure 16. This distance and the other distances mentioned herein are measured by orthogonally projecting one of the ends of the support structure onto a plane including the longitudinal and steering axes of the bicycle, and taking a measurement to that projection. Alternatively, this stem axis could be orthogonally projected onto a measurement point resident in a plane containing the end 414, which plane is parallel to this steering axis 11 and the longitudinal axis of the bicycle. In an exemplary embodiment, horizontal reference range 404 extends from 0 to 185 mm. In one particular exemplary embodiment, horizontal reference range is approximately 89 mm. Vertical reference line 406 is the distance from the bottom of stem head 416 to forward end point 414.

Stem head 416 is connected at quill 20 at distal end 24 of stem 12. Stem vertical adjustment range 420 defines the extent to which stem 12 can upwardly and axially extend from the handlebar controlled vehicle. In an exemplary embodiment, stem vertical adjustment range 420 is in the range of 0 to 100 mm. In one particular exemplary embodiment, stem vertical adjustment range is approximately 50 mm.

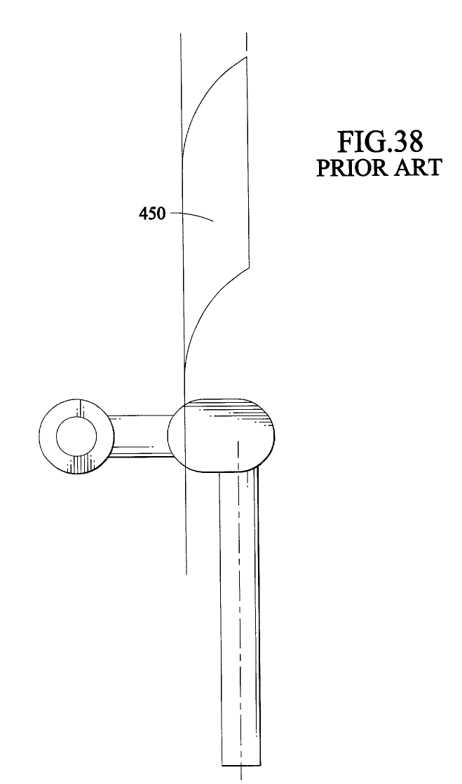

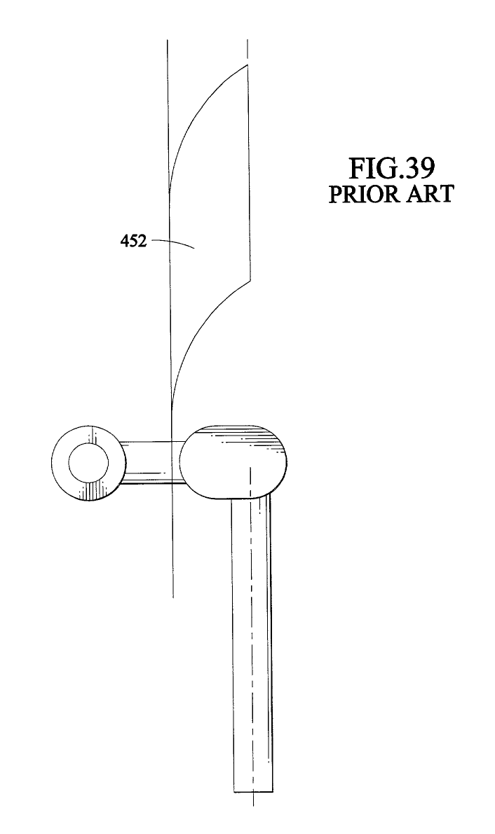

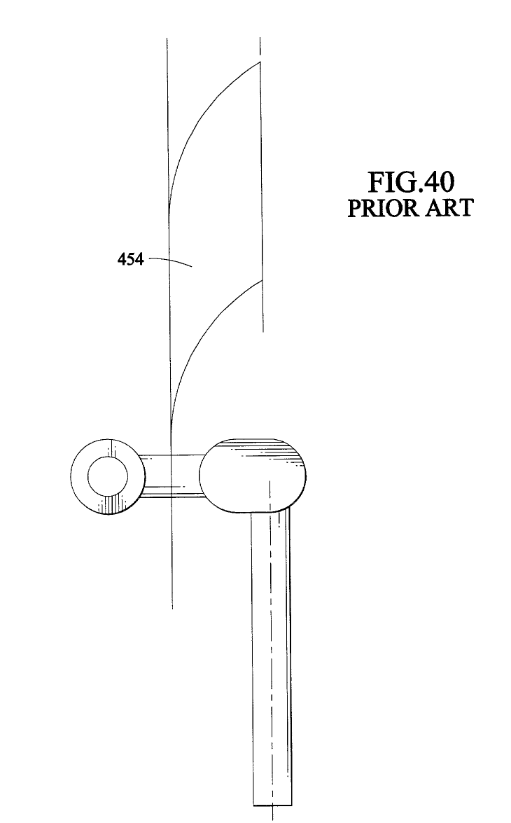

A forward stem envelope 400 is an area defined by three arcs 422, 424 and 426 and one line 428 connecting points A, B, C and D. Forward stem envelope 400 illustrates the range of positions available to the rider for the location of forward end point 414 of structure 16 when distal end 24 of stem 12 is a forwardly projecting position. The rotation of extensions 14, 15 and structure 16 about stem extension axis 412 and structure extension axis 418, and vertical stem adjustment range 420 of system 10, allows the rider to adjust and secure forward end point 414 within any point defined by the forward stem envelope 400. A rearward stem envelope 402 is an area defined by five arcs 430, 432, 436, 438 and 440 and one line 434 connecting points G, D, B, E, F and C. Rearward stem envelope 402 illustrates the range of positions available to the rider for the location forward end point 414 of structure 16 when distal end 24 of stem 12 is in a rearwardly projecting position (as shown in FIG. 7B). The forward and rearward positioning of stem 12 (flip-flop positioning) in combination with horizontal reference range 404, vertical stem adjustment range 420 and the 120 degree range of pivot defines a total available reach 408, and a total available height 410 of system 10. In an exemplary embodiment, total available reach falls within the range of 0 to 314 mm and total available height falls within the range of 0 to 245 mm. In one particular exemplary embodiment, total available reach is approximately 218 mm and total available height adjustment is approximately 175 mm. The prior art handle bar assembly configurations illustrated in FIGS. 38 through 40 provide a range of total available reach from 44.72 mm to 59.86 mm and a range of total available height from 212.85 mm to 243.76 mm. The area of adjustability envelopes 450, 452 and 454 of shown on FIGS. 38 through 40, respectively, are significantly smaller than the total range of adjustability of structure 16 defined by forward and rearward envelopes 400 and 402. The increased range of adjustability allows system 10 to ergonomically adapt to a wider range of riders and riders' needs. System 10 provides the rider with greater adjustment flexibility. The increased range of adjustability of system 10 allows system 10 to quickly and easily adapt to the needs of each rider.

Forward and rearward stem envelopes 400 and 402 collectively define a two dimensional geometric shape 401 in the plane of the longitudinal axis of the bicycle. Two dimensional geometric shape 401 defines the adjustable operating range of the rider control device with respect to the steering axis of the handlebar-steered vehicle. Shape 401 has a non-zero area, unlike many prior art handlebars which can be adjusted through an arc. Arcs 402, 424, 438, 440 432, 426, and 436 can also be represented as part of a polygonal shape. Shape 401 has a non-zero height and a nonzero reach, in which the maximum height adjustment is at least 245 millimeters and the reach adjustment is at least 314 millimeters.

VII. A Bicycle Safety System for a Bicycle including a Garage Door Opener

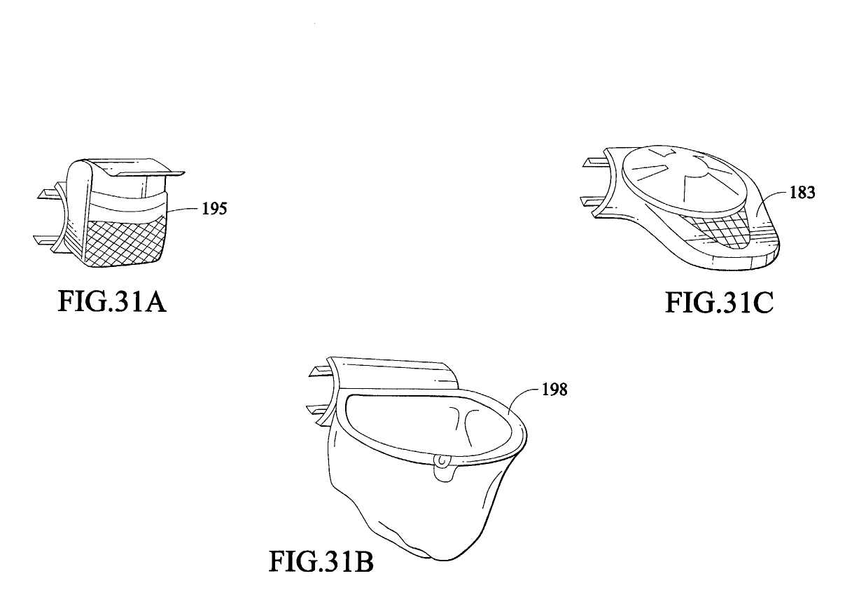

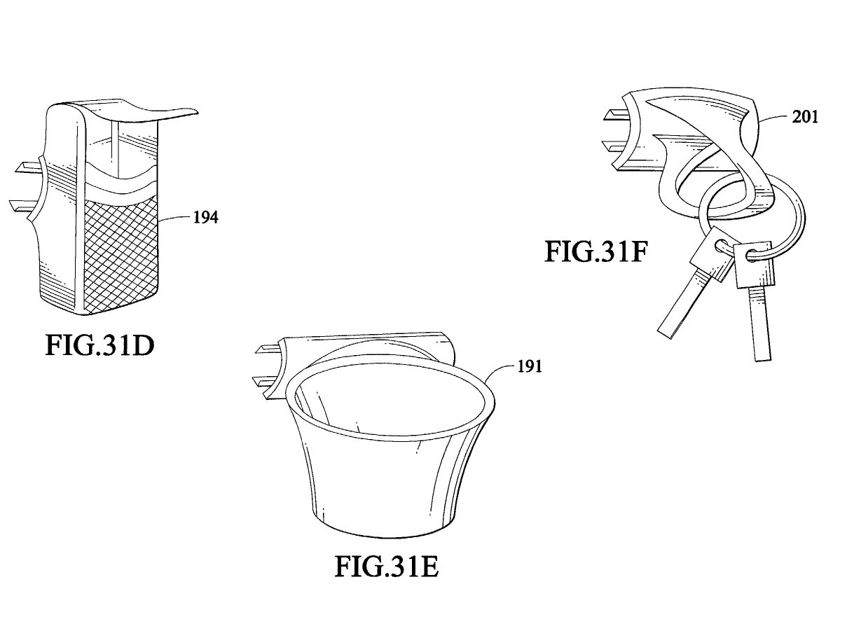

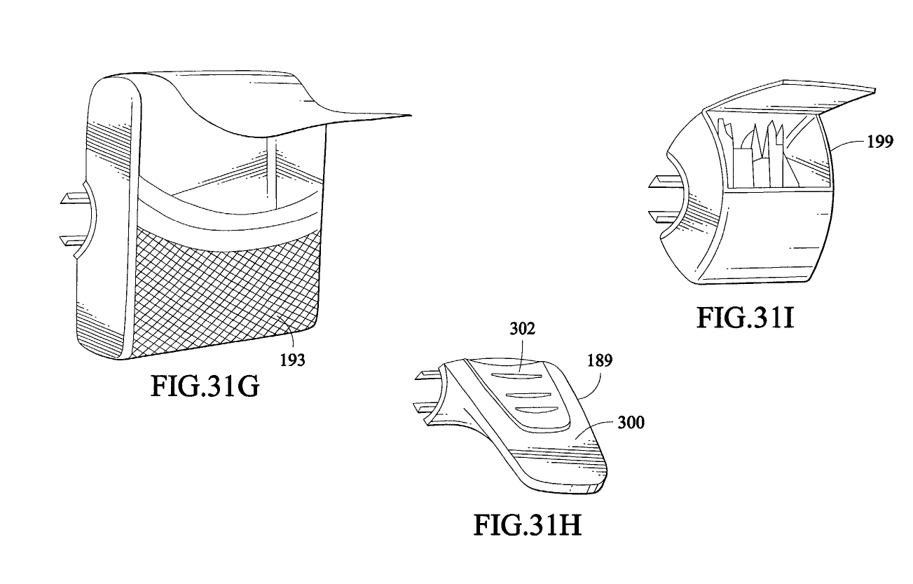

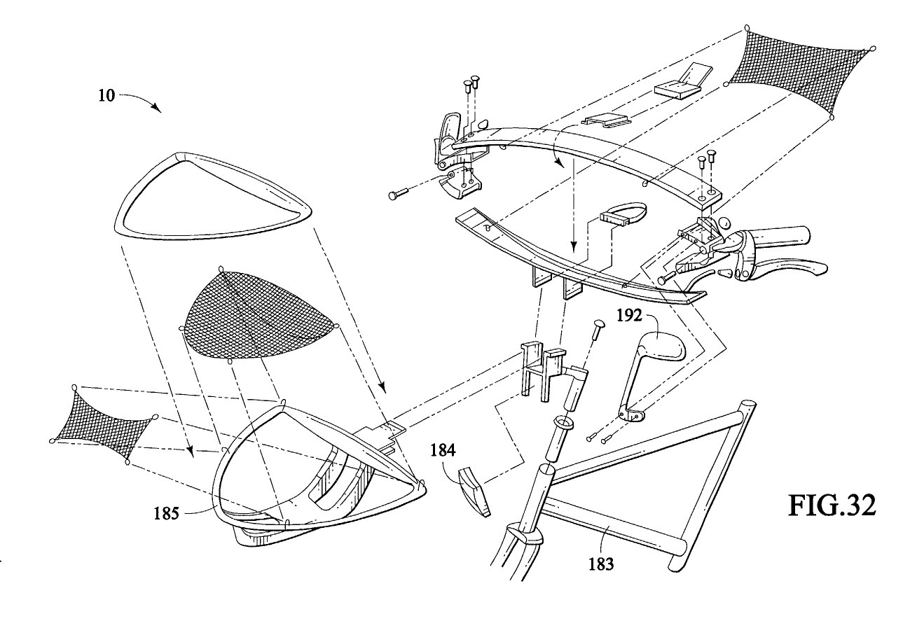

FIGS. 29 and 31H illustrate a remote garage door opener 189 attached to a rider control system or handlebar assembly. Garage door opener is a remote control device of conventional design including a body 300, a pushbutton 302 and a control circuit. Body 300 substantially encloses the control circuit and includes and an opening for pushbutton 302. Body 300 is configured to be removably and integrally coupled to the rider control system or the handlebar assembly. Body 300 can be configured in a variety of shapes, sizes and colors. Pushbutton 302 is coupled to body 300 at the pushbutton opening of body 300 and to the control circuit. Garage door opener control circuits are well known. Any of these well known circuits can be included into the structure of remote garage door opener 189.

Remote garage door opener 189 allows the rider to gain quick, easy, safe and efficient ingress into a garage or storage area. Remote garage door opener 189 connected to the rider control system or the handlebar assembly of a bicycle allows the rider to remain on the bicycle at a location outside of the garage, or storage area, actuate the garage door opener while on or while riding the bicycle and entering the garage door or storage area without having to get off the bicycle or stop the bicycle. The garage door opener feature on the bicycle handlebar assembly or the rider control system increases the safety of riding the bicycle by allowing the rider to easily activate and open a garage door while mounted on or riding the bicycle and enter the garage door without having to stop or dismount the bicycle. This feature is particular useful in inclement weather, in the evening, or in situations where the rider is concerned about quick and safe entry into the garage or storage area.

VIII. Rider Steering Control Device Having Non-cylindrical Mounting Surfaces and Corresponding Accessories having Non-cylindrical Mounting Surfaces

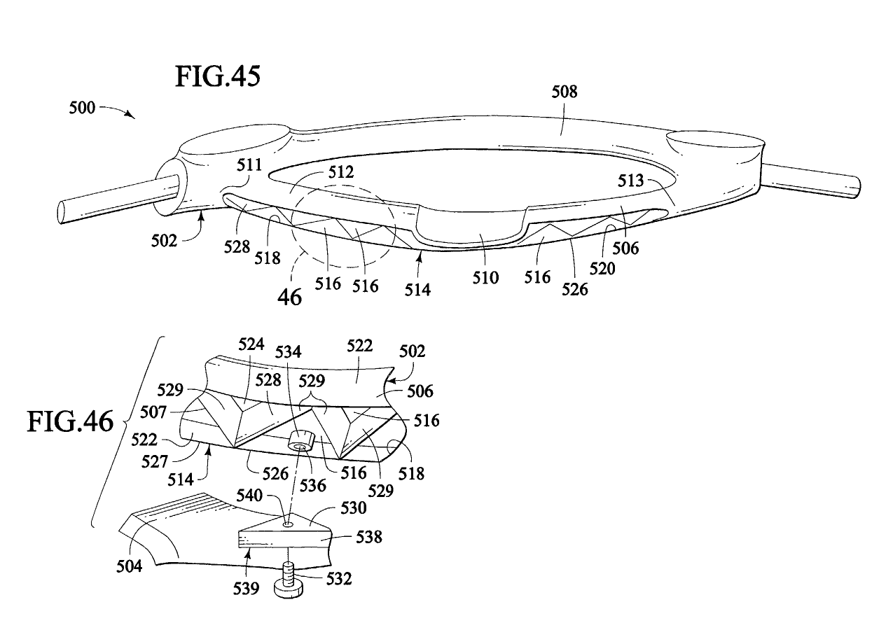

FIGS. 45 and 46 illustrate one example of the matable engagement of an accessory to a rider control device for a bicycle. The rider control device, indicated generally at 500, includes an elongate support structure 502 and at least one accessory 504. In an exemplary embodiment, structure 502 has the same features as integrated support structure 16 and includes generally parallel lower and upper integrally formed spars 506, 508. Alternatively, structure 502 can have a single spar or other elongated configurations. Lower spar 506 includes an integrally formed central region 510, a generally concavely arcuate, outer upper surface 512 and a generally convexly arcuate, outer lower surface 514. Surfaces 512 and 514 can also be approximately horizontally planar or take another elongated shape without departing from this aspect of the invention. Central region 510 is configured to connect to a stem structure (as similarly shown in FIG. 6) that itself is pivotally connected to the bicycle.

A set of non-cylindrical first mounting surfaces 516 are formed within left and right cavities or channels 518, 520 within lower spar 506. Each channel is defined between elongated, opposing interior surfaces or sidewalls 522 and extends from near central region 510 to opposite longitudinal ends 511, 513. The sidewalls 522 extend from a generally planar, upper interior surface 524 within lower spar 506 and down to an opening 526 defined by an elongated rim 527 on lower surface 514. Left and right channels 518, 520 each include a truss 528 downwardly extending from interior upper surface 524 of spar 506 so that the truss has a bottom 507 slightly set back from lower surface 514. Truss or web 528, which in the illustrated embodiment consists of flat, vertically-disposed panels or partition walls 529 connected end-to-end and that alternate angularly, increases the strength of lower spar 506 and cooperatively defines the sets of preferably triangular non-cylindrical mounting surfaces 516 on interior surface 524 with the sidewalls 522.

The non-cylindrical first mounting surfaces 516 allow for accessory 504 to matably engage and fit into lower spar 506. Accessory 504 is formed with a non-cylindrical second mounting surface 530 configured to preferably matably engage the non-cylindrical first mounting surface 516 and adjacent partition walls 529 while preferably connecting to one another with a fastener 532. Also in the preferred embodiment, as shown in FIG. 46, an attachment boss 534 extends downwardly from the interior upper surface 524 of lower spar 506 into left channel 512. Boss 534 includes a threaded opening 536 configured to receive the fastener 532 extending from accessory 504.

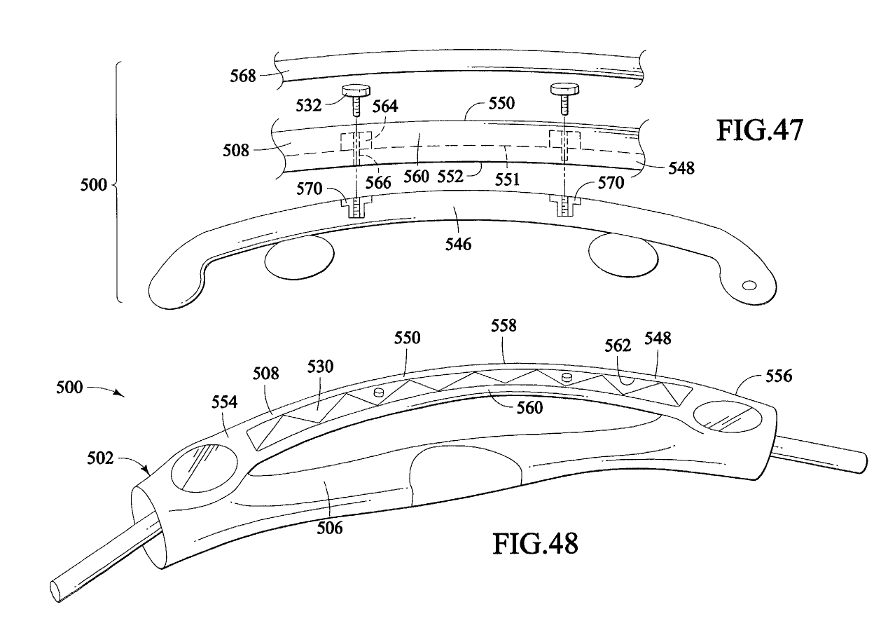

Referring again to FIG. 46, accessory 504 includes an upward extension 538. An upper surface of the extension 538 is the same as mounting surface 530. Extension 538 preferably has a periphery constituted by one or more sidewalls 539, preferably noncircular in horizontal cross-section, which engage with respective ones of the partition walls 529. This defines an exact mounting position of the accessory 504 on the lower spar 506. A through hole 540 extends through the extension 538 for receiving fastener 532. Extension 538 can be integrally formed with, or a separate part attached to, accessory 504. It will be appreciated that a plurality of accessories 504, each with a non-cylindrical second mounting surface 530, can matably engage other similar non-cylindrical mounting surfaces of structure 502 along channels 518, 520 and within channel 562 (as shown in FIGS. 47-48) of upper spar 508.

In yet other alternatives, the non-cylindrical first mounting surfaces 516 of the spars 506, 508 can take other forms including outwardly extending projections and alternatively shaped non-cylindrical recesses. Furthermore, the boss 534 and extension 538 may be configured so that the boss abuts the extension, and in turn, defines the first mounting surface 516, or alternatively fits within the through-hole 540 of the extension or a counter bored portion thereof. The second mating surface 530 may also be configured to rest on the web or truss 528 rather than fit within the truss. In these alternatives, the fastener 532 may be eliminated by integrally forming the extension 538 with the structure 502, gluing the extension 538 to the structure 502 between the first and second mounting surfaces 516, 530 or simply providing the extension 538 with a press- or snap-fit within cavity or channel 518 or 520 to secure the accessory 504 to the structure 502.

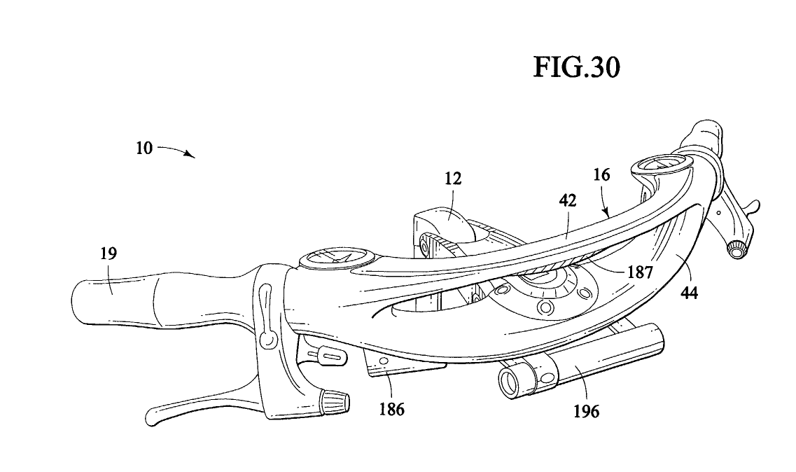

It will also be appreciated that accessory 504 can be any device of utility to a cyclist and can consist of or include, but is not limited to, a bell, a computer, a light, a basket, a horn, a reflector, a heart rate monitor, a garage door opener, a compass, an odometer, a cyclometer, a drink holder, a mirror, a radio holder, an alarm, a cell-phone holder, a beeper holder, a lock holder a global positioning device, a tool pack, and a key ring holder (as similarly shown in FIGS. 30-32).

The non-cylindrical first and second mounting surfaces 516, 530 allow for an appearance of integral attachment of accessory 504 to lower spar 506 by at least partially enclosing or covering the fastener 534 within the cavity 518 and between the spar 506 and accessory 504 so that the fastener 536 cannot be viewed from an exterior of the structure 502, and a rider cannot accidentally directly touch the fastener 532. This enables accessory 504 to be mounted in a manner that eliminates outwardly extending, sharp surfaces of fasteners 532 from contacting riders and others who may contact accessory 504. Moreover, the mutual engagement of non-cylindrical mounting surfaces 516, 530 provides a rider control device aesthetically pleasing to the rider and others.

IX. Rider Steering Control Device having a Cavity for the Attachment of Accessories and the Enclosure of Fasteners

FIGS. 47 and 48 illustrate the mounting of an accessory bar 546 to rider steering control device 500 for a bicycle and includes support structure 502 with similar features numbered the same as in FIGS. 45 and 46. In this embodiment, upper spar 508 of structure 502 has an elongate member 548 having generally opposing upper and lower outer surfaces 550, 552 disposed between first and second end sections 554, 556. Two elongated sidewalls 558, 560 extend from the upper surface 550 of upper spar 508 to define, cooperatively with a bottom wall 551, an elongate channel or cavity 562. Upper spar 508 also has at least one, and preferably two, mounting bosses 564 upwardly extending from bottom wall 551 into channel 562. Mounting bosses 564 each include a threaded bore or through-hole 566 that also extends through bottom wall 551 and is configured to receive a fastener 532. Each mounting boss 564 supports fastener 532 for connecting an accessory 504 or an accessory bar 546 to upper spar 508. Channel 562 enables raised and/or sharp surfaces of fastener 532 to be disposed within upper spar 508.

A cover 568 is provided with a cushion of a flexible, elongate sheet of resilient material, the same as cushionable cover 86. Cover 568 is connected to and covers channel 562 of upper spar 508, and in turn, covers the portion of fasteners 532 disposed within channel 562. Alternatively, structure 502 can contain multiple cushionable covers configured to cover channel 562 or to cover other regions of structure 502 to provide padding. It will also be appreciated that the cover 568 may be placed over only certain portions of channel 562 or may not include a cushion at all.

In the preferred embodiment, the fasteners 532 extending through bores 566 of mounting bosses 564 also extend out of lower surface 552 of upper spar 508 into fastener mounting features such as a threaded bore in an insert 570 on accessory bar 546. Alternatively, the fasteners 532 can extend upward from or through accessory bar 546 or other accessories into lower surface 552 of upper spar 508.

X. Accessory Support Member Configured to Matably Engage a Steering Control Device of a Bicycle

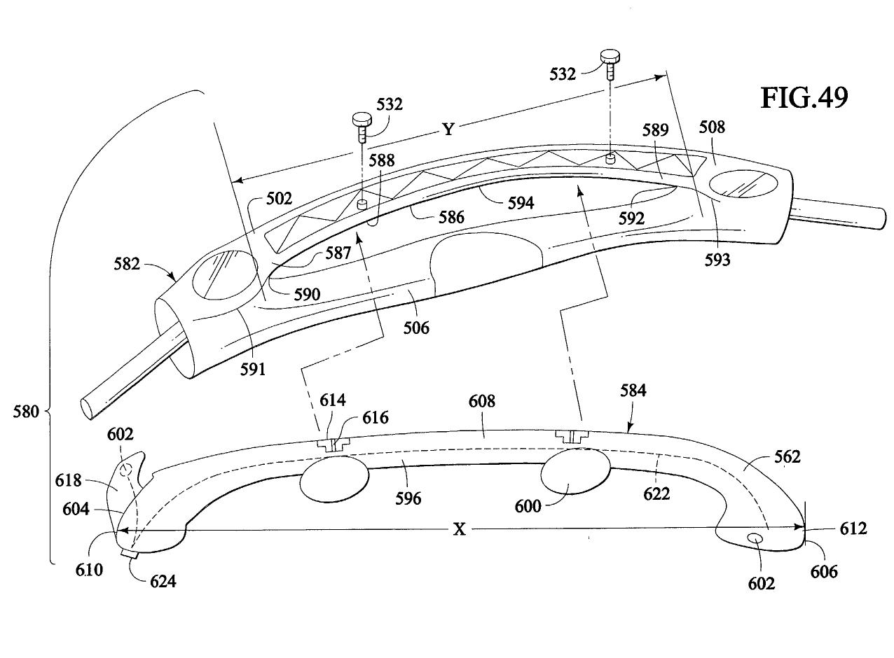

An accessory mounting system 580 for a steering control device 582 is illustrated in FIG. 49 and includes an accessory support bar or member 584. The steering control device 582 includes support structure 502 with an annular, generally oval shaped surface 586 defining an oval shaped opening 588 formed between the upper and lower spars 508, 506. Two longitudinal ends 587, 589 of the oval surface 586 are disposed near joints 591, 593 between the upper and lower spars 508, 506. The ends 587, 589 define first and second abutments 590, 592. Similarly, the portion of the oval surface 586 at a central area of the upper spar 508 defines third abutment 594. Alternatively, the steering control device can include any structure having first and second abutments 540, 542 for engaging and holding accessory support member 584.

The accessory support member 584 includes at least one accessory 600 and an accessory control 602. The bar 584 is an elongate separate spar 596 made of a generally elastic, resilient material, and in one embodiment has opposing first and second interference end surfaces 604, 606 and a third central surface 608. First and second surfaces 604, 606 are positioned substantially orthogonal to third surface 608 so as to face each other, and preferably are integrally formed with, and laterally spaced apart by, third surface 608. First and second surfaces 604, 606 are configured to matably engage or “snap-on” to structure 502 at opening 588 by respectively engaging abutments 590, 592. Third surface 608 rests against abutment 594 for vertical stability.

A distance x from an outer edge 610 of the first interference surface 604 to an outer edge 612 of the second interference surface 606 is sized slightly larger than the distance y. The distance y is defined as the length of oval shaped opening 588. As a result of the relationship between x and y, bar 584 is elastically deflected during attachment to structure 502 and remains deflected while secured to the abutments 590, 592.

In the preferred embodiment, third surface 608 includes at least two mounting recesses with inserts 614 configured to receive fasteners, such as fasteners 532, extending from upper spar 508 for further securing mounting bar 584 to structure 502. Each mounting insert 614 includes a threaded bore 616 for engaging fastener 532. In an alternative embodiment, bar 584 further includes an extension 618 configured to provide a larger engaging surface area for either interference end surfaces 604, 606 and a location for housing an accessory control 602.

The accessory 600 may be removably attached to bar 584, and can include, but is not limited to, a bell, a computer, a light, a basket, a horn, a reflector, a heart rate monitor, a garage door opener, a compass, an odometer, a cyclometer, a drink holder, a mirror, a radio, a radio holder, a walkman holder, an alarm, a cell-phone holder, a beeper holder, a lock holder a global positioning device, a tool pack, a jack provider for headphones, a key ring holder, or any other accessory supportable by the bar 584.

Accessory 600 also is preferably at least partially integrally formed with bar 584. For instance, accessory control 602 is a remote control device, such as a pushbutton, switch, or similar device, connected to bar 584 in a position remote from accessory 600, and preferably within reach of the rider such that the rider can actuate control 602 without removing his grip from the gripping surfaces of structure 502. A communication link 622, here shown as a physical communication link 622, operably connects accessory control 602 to accessory 600. Communication link 622 can include an electrical conductor, an optical connection, or any other conventional communication linking mechanism such as a wireless radio link. It will also be appreciated that non-physical communication links such as by a transmitter/receiver device that do not require any routing passages can be used instead. However, physical communication link 622 is routed internally through structure 502 thereby enclosing all cables, conduits, etc. that may be used as part of the communications link. Control 600 enables an accessory 600 to be mounted at any point on bar 584 without requiring the user to directly contact the accessory in order to actuate the accessory. As an alternative, the accessory control 602 can be placed in the extension 618 for convenient access by a rider. Furthermore, this structure allows optimum positioning of accessories on bar 584 so that bar 584 easily accommodates multiple accessories.

In the preferred embodiment, bar 584 also includes a power source receiver 624. Power source receiver 624 is connected to bar 584 and is operably coupled to control 602 in accessory 600. Power source receiver 624 is configured to receive a power source, such as a battery, a power line, or other electrical power device.

XI. Equipment Mounting Bar for a Tubular Handlebar of a Bicycle

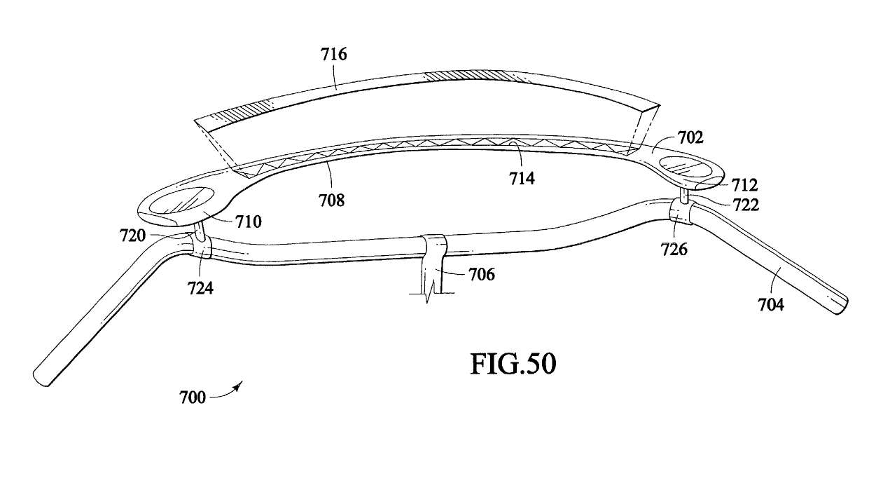

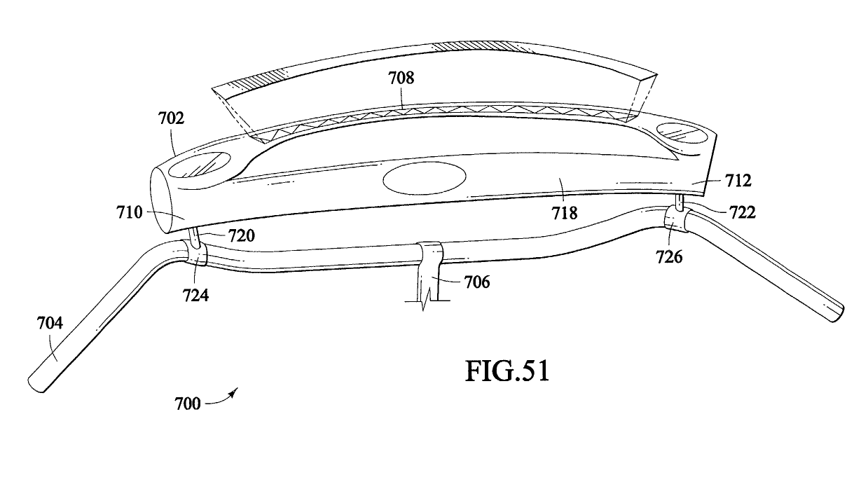

Referring to FIG. 50, a rider control system 700 has an equipment mounting bar 702 removably mounted on a conventional tubular handlebar 704 of a bicycle 706. The bar 702 includes an elongated first spar 708 with first and second attachment ends which take the form of brackets 710, 712 connected to the tubular handlebar. In an exemplary embodiment, elongated first spar 708 resembles upper spar 508 of structure 502. The first spar 708 includes non-cylindrical mounting surfaces 714 for mounting a piece of equipment, such as a display, a control, an accessory or accessory bar. Since the same accessory bar and accessory attachment already described for FIGS. 45-49 are included in this embodiment, it is not repeated here.

Similarly, communication lines (as shown in FIG. 16) connecting an accessory with a remote control can be embedded in the spar 708 and enclosed by a cover 716 with a cushion. This structure will also provide an appearance that all equipment is integrally attached to the spar by covering all connectors and communication links, which in turn positions connectors, fasteners and communication links at inaccessible positions that prevent harm to a rider and damage to the accessory.

In an alternative exemplary embodiment, as shown in FIG. 51, the equipment mounting bar resembles structure 502 having both an upper (first) spar 708 and lower (second) spar 718. Here, lower spar 718 is configured to removably attach to the tubular handlebar 704. It will be appreciated, however, that the upper spar 708 can be configured to connect directly to the tubular handlebar 704 instead.

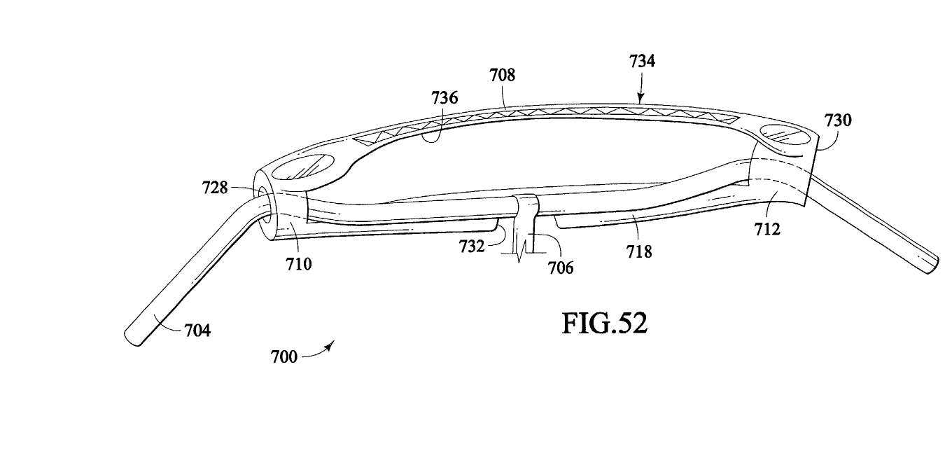

While these embodiments show the use of extenders 720, 722 and clamps 724, 726, it will be appreciated that there are many other ways to connect the equipment bar 702 to the handlebar 704. For instance, as illustrated in FIG. 52, the attachment ends 710, 712 may have sleeves 728, 730 and a recess 732 for fitting the handlebar 704 through the equipment bar 734. This permits the handlebar 704 to extend out of a main opening 736 defined between the two spars 708, 718.

While a preferred embodiment of the present invention has been described and illustrated, numerous departures therefrom can be contemplated by persons skilled in the art, for example, integral support structure could include an auxiliary accessory support platform configured to support accessories, controls and displays that is removably connected to the structure. Therefore, the present invention is not limited to the foregoing description but only by the scope and spirit of the appended claims.

We claim:

1. A rider steering control device pivotally coupled to a frame of a bicycle, comprising:
an elongate support structure including two longitudinal ends and an integrally formed central region adopted for pivotally coupling to the bicycle frame, the support structure having interior surfaces defining at least one cavity having a plurality of first mounting surfaces disposed within the cavity; and
at least one accessory having a second mounting surface matably engaging a selected one of the first mounting surfaces of the support structure within the cavity.

2. The device of claim 1, further comprising partition walls separating the first mounting surfaces from each other.

3. The device of claim 2, wherein said partition walls intersect to form a web of separated triangular holes and define triangular said first mounting surfaces.

4. The device of claim 2, wherein said partition walls intersect with each other to define a plurality of holes within the cavity.

5. The device of claim 4, wherein said accessory further includes an extension with a periphery shaped for engaging said partition walls for providing a snug fit within said holes.

6. The device of claim 1, further comprising a fastener for securing the second mounting surface toward first mounting surface, and extending at least partially within the cavity.

7. The device of claim 6, wherein the support structure and the accessory cooperatively cover the fastener so that the fastener cannot be viewed from an exterior of the support structure when assembled.

8. The device of claim 6, wherein the fastener does not extend outside of an area between the accessory and the support structure in an assembled state so that a human hand cannot inadvertently contact the fastener directly during use of the rider steering control device.

9. The device of claim 1, wherein the accessory further includes an extension with a distal surface defining the second mounting surface, and wherein said extension is provided for extending into said cavity for abutting said first mounting surface against said second mounting surface.

10. The device of claim 1, wherein the connection either includes an adhesive used between the first and second mounting surfaces or includes the extension being configured for a snug fit within the cavity.

11. The device of claim 1, wherein the connection includes a fastener extending from the accessory, and the support structure has a threaded boss extending within the cavity for receiving the fastener.

12. The device of claim 11, wherein the first mounting surface is either an interior bottom surface of the support structure defining the cavity or a top surface of the boss.

13. The device of claim 1, wherein the elongate support structure includes upper and lower elongate spars extending in generally parallel directions relative to each other, and wherein the central region is disposed on the lower spar.

14. The device of claim 13, wherein the accessory is connected to one of the lower and upper spars.

15. The device of claim 1, further comprising a cover attached to and substantially covering the cavity.

16. The device of claim 15, wherein the cover has a cushion for providing comfort to a rider or to prevent harm to a rider.

17. The device of claim 1, wherein the support structure is adapted to be mounted to a tubular handlebar with a central region pivotally coupled to the bicycle along a steering axis of rotation.

18. The device of claim 1, further comprising a plurality of accessories, each accessory engaging one of the first mounting surfaces, wherein each first mounting surface engaged with an accessory has a mounting boss extending within the cavity for engaging the accessory.

19. The device of claim 1, wherein the support structure includes a truss within the cavity that defines separate first mounting surfaces.

20. A rider steering control device pivotally coupled to a frame of a bicycle, comprising:
an elongate support structure including two longitudinal ends and an integrally formed central region adopted for pivotally coupling to the bicycle frame, the support structure having interior surfaces defining at least one elongated cavity generally extending longitudinally along the support structure and a rim defining an elongated opening to said cavity; and
at least one accessory mounted to said support structure at said cavity through said opening.

21. The device of claim 20, wherein said cavity is configured for providing multiple alternative mounting locations for engaging said accessory.

22. The device of claim 20, wherein said cavity at least extends from near said central region to near at least one of said longitudinal ends.

23. The device of claim 20, wherein said cavity extends continuously from near one said longitudinal end to near the other said longitudinal end.

24. A rider steering control device for a bicycle configured for attachment via a fastener of at least one accessory, the device comprising:
at least one elongate first spar pivotally coupled to the bicycle, the first spar having first and second end sections, generally opposing first outer and second outer surfaces and at least two interior sidewalls extending from the first outer surface to an interior bottom wall to define an elongate cavity disposed between the first and second end sections of the first spar and between the sidewalls, the first spar having at least one first through-hole extending through the bottom wall of the first spar from the cavity to the second outer surface, the first through-hole configured to receive at least a portion of the fastener for connecting the accessory to the first spar; and
a cover attached to the first spar for at least covering a portion of the cavity.

25. The device of claim 24, wherein the first spar includes at least one mounting boss for receiving the fastener, the mounting boss coaxially formed around the first through-hole and extending upwardly into the cavity from the bottom wall.

26. The device of claim 24, wherein the accessory extends from the second outer surface upon attachment to the first spar.

27. The device of claim 24, wherein the end sections of the first spar each have an attachment bracket for mounting to a tubular handle bar of a bicycle.

28. The device of claim 24, further comprising a second elongate spar extending substantially parallel to the first spar and wherein the second spar is connected to the first spar near at least one of the first and second end sections.

29. The device of claim 24, wherein the cover has a cushion.

30. An accessory mounting system with an accessory support member for supporting at least one accessory and configured for mounting to a steering control device of a bicycle, the support member comprising:
an elongate bar having opposing first and second interference surfaces laterally spaced apart and facing each other, the first and second interference surfaces of the bar configured to matably engage first and second opposing abutments, respectively, of the steering control device; and
at least one accessory mounting region defined on the bar.

31. The accessory mounting system of claim 30, wherein the engagement of the first and second interference surfaces with the abutments deflects the bar for securing the bar between the abutments.

32. The accessory mounting system of claim 30, wherein the distance from an outer edge of the first interference surface to an outer edge of the second interference surface is slightly larger than the distance between the first and second abutments.

33. The accessory mounting system of claim 30, wherein the support member includes an accessory control connected to the bar and positioned remote from the accessory mounting region.

34. The accessory mounting system of claim 30, wherein the accessory support member further comprises an extension outwardly extending from one of the first and second interference surfaces, the extension configured to further engage the steering control device.

35. The accessory mounting system of claim 34, wherein the accessory control is connected to the extension.

36. The accessory mounting system of claim 30, wherein the rider control device defines an opening and the bar is configured to conform to an interior surface of the opening.

37. The accessory mounting system of claim 30, wherein the accessory support member further comprises a power source receiver connected to the bar.

38. The accessory mounting system of claim 30, wherein a fastener is disposed on one of the steering control device and the bar and a hole is disposed on the other of the steering control device and the bar, the hole adapted to receive the fastener.

39. An accessory support member for supporting at least one accessory and configured for mounting to a steering control device of a bicycle, the support member comprising:
an elongate tubular bar defining an accessory mounting region;
an accessory control connected to the bar and disposed remotely from the accessory mounting region;
an accessory mounted to the bar; and
a communications link connecting the accessory control to the accessory, the communications link being configured so that it is not exposed to an exterior of the bar, wherein the bar is removably securable on the steering control device.

40. The accessory support member of claim 39, wherein the communications link is selected from the group consisting of an electrical conductor, a transmitter/receiver device, and an optical connection.

41. An equipment mounting bar for a tubular handlebar of a bicycle, the bar comprising:
an elongated first spar having first and second attachment ends for attaching to the tubular handlebar, opposing first and second outer surfaces between the first and second attachment ends, two elongated sidewalls and a bottom wall cooperatively defining an elongate cavity; and
a piece of equipment mounted on the spar adjacent the cavity.

42. The bar of claim 41, further comprising a cover covering at least a portion of the cavity.

43. The bar of claim 41, wherein the first spar has a plurality of non-cylindrical mounting surfaces within the cavity for selectively mounting the piece of equipment on at least one of said mounting surfaces.

44. The bar of claim 41, further comprising a second spar generally parallel to the first spar, the first spar having ends respectively connected to ends of the second spar so that the first and second spars cooperatively define an opening between the spars, and wherein the second spar is connectable to the tubular handlebar.

45. The bar of claim 41, further comprising at least one fastener for connecting a piece of equipment to the first spar, the first spar having at least one through-hole extending through the bottom wall of the spar and from the cavity to the second outer surface, the through-hole being configured to receive at least a portion of the fastener.

46. The bar of claim 45 wherein the piece of equipment is selected from the group consisting of accessories, controls, displays, and a combination thereof.

47. The bar of claim 41, further comprising an equipment control mounted to the first spar and positioned remotely from a corresponding piece of equipment.

48. The bar of claim 47, further including a communication link between the piece of equipment and equipment control that is not exposed to an exterior of the bar.
